(19) United States
(12) Patent Application Publication
(10) Pub. No.: US 2026/0278355 A1
(43) Pub. Date: Sep. 17, 2026

(54) Systems and Methods for Construction and Implementation of Efficient Feature Extractors

(71) Applicant: DiffLogic Inc., Dover, DE (US)

(72) Inventor: Felix Petersen, Santa Clara, CA (US)

(73) Assignee: DiffLogic Inc., Dover, DE (US)

(21) Appl. No.: 19/567,781

(22) Filed: Mar. 16, 2026

Related U.S. Application Data
(60) Provisional application No. 63/772,329, filed on Mar. 14, 2025.
(60) Provisional application No. 63/772,339, filed on Mar. 14, 2025.
(60) Provisional application No. 63/772,334, filed on Mar. 14, 2025.
(60) Provisional application No. 63/901,796, filed on Oct. 19, 2025.
(60) Provisional application No. 63/927,929, filed on Nov. 30, 2025.

(51) Int. Cl. G06N 3/0495

(52) U.S. Cl. CPC G06N 3/0495

(57) ABSTRACT

Systems and methods are disclosed for constructing and implementing feature extractors for inference on structured inputs. A computing system determines feature directions from a dataset, quantizes them into a restricted set of value representations, and iteratively updates the dataset. The iterative process removes contributions corresponding to the quantized feature directions while retaining the residual quantization error, thereby generating additional quantized feature directions. In some embodiments, shared arithmetic structures are constructed across multiple feature extractors by identifying channel tuples having common or proportional coefficients and creating merged channels. The resulting feature extractors may be synthesized into hardware representations, including FPGA configurations and ASIC implementations, and may generate Boolean, multi-bit, or integer-valued feature outputs.

### RELATED APPLICATIONS

This application claims priority to and benefit under 35 U.S.C. § 119 to U.S. Provisional Patent Application No. 63/772,334, filed on Mar. 14, 2025, titled “Method for Construction and Synthesis of Efficient Feature Extractors” (DFL0300); U.S. Provisional Patent Application No. 64/006,864, filed on Mar. 16, 2026, titled “Systems and Methods for Construction and Implementation of Efficient Feature Extractors” (DFL0301); U.S. Provisional Patent Application No. 63/772,329, filed on Mar. 14, 2025, titled “Extended Differentiable Logic Gate Networks” (DFL0100); U.S. Provisional Patent Application No. 64/002,139, filed on Mar. 10, 2026, titled “Logic Gate Network Systems, Methods, and Devices” (DFL0101); U.S. Provisional Patent Application No. 63/772,339, filed on Mar. 14, 2025, titled “Efficiency Improvements for Training Differentiable Logic Gate Networks” (DFL0400); U.S. Provisional Patent Application No. 63/901,796, filed on Oct. 19, 2025, titled “Digital Neural Inference Integrated Circuit with Predominantly Latent Parameterization Circuitry” (DFL0900); and U.S. Provisional Patent Application No. 63/927,929, filed on Nov. 30, 2025, titled “Training Apparatus with Integrated Circuits for Training Logic Gate Networks” (DFL1000), each of which is hereby incorporated by reference in its entirety.

This application also relates to and can be further understood in the context of U.S. patent application Ser. No. 19/301,717, filed on Aug. 15, 2025, titled “Logic Gate Networks Generated Using Differentiable Logic Gate Models” (DFL0800); and U.S. patent application Ser. No. 19/301,717, filed on Aug. 15, 2025, titled “Logic Gate Networks Generated Using Differentiable Logic Gate Models” (DFL0920), which is hereby incorporated by reference in its entirety.

### TECHNICAL FIELD

This application relates generally to machine-learning inference and digital hardware implementation. More specifically, this application relates to systems and methods for constructing, quantizing, optimizing, and synthesizing efficient feature extractors for implementation in programmable logic and integrated circuits.

### BRIEF DESCRIPTION OF THE DRAWINGS

FIG. 1 is a block diagram of an example feature extractor construction and/or synthesis computing system, according to one embodiment.

FIG. 2 is a flowchart illustrating an example method for constructing a plurality of quantized feature extractors, according to one embodiment.

FIG. 3 is a flowchart illustrating an example method for constructing a quantized feature extractor using search-based quantization of a feature direction, according to one embodiment.

FIG. 4 is a flowchart illustrating another example method for constructing a quantized feature extractor, according to one embodiment.

FIG. 5 is a flowchart illustrating an example method for constructing a shared hardware implementation of a plurality of feature extractors, according to one embodiment.

FIG. 6 is a functional block diagram of an example digital integrated circuit to generate feature outputs, according to one embodiment.

FIG. 7A is a schematic diagram illustrating direct aggregation of selected values from a structured input region to generate one or more aggregated outputs, according to one embodiment.

FIG. 7B is a schematic diagram illustrating a hierarchical implementation in which intermediate functions are used to generate outputs, according to one embodiment.

FIGS. 8-13 are schematic visualizations of various examples of quantized feature directions or feature extractor kernels for image data, according to various embodiments.

FIG. 14 is a graph visualization of an example synthesized hardware representation or logic netlist corresponding to a feature extractor circuit, according to one embodiment.

### DETAILED DESCRIPTION

Machine-learning models are increasingly deployed in real-world inference settings where compute, power, latency, determinism, and verifiability matter as much as raw accuracy. For example, inference models may be deployed on embedded devices, industrial control systems, cyber-physical systems, and other environments with strict timing constraints. In such settings, even modest increases in model latency can reduce control bandwidth, limit achievable performance, and/or constrain the complexity of the model that can be used. In reinforcement-learning (“RL”) deployments, these constraints can be particularly acute because decisions may be made at high frequency and directly coupled to physical processes. For example, real-time reinforcement-learning agents have been explored for controlling complex systems such as tokamaks, fiber-laser systems, and network systems, where low latency can limit agent expressivity and overall system performance. In at least some reported tokamak-control contexts, latency budgets on the order of tens of microseconds (e.g., 50 μs) have been identified as constraining agent expressivity and performance. In other systems, such as some low-latency trading, networking, trigger processing, or other low-latency environments, latency specifications may be below lus, and in some cases, below 100 ns. Such latency targets may be unachievable using conventional neural network systems.

Conventional deep neural networks (e.g., convolutional neural networks (“CNNs”), transformer-based architectures, and the like) are typically parameterized by real-valued weights and biases and rely on matrix multiplications and other dense numeric operations. These operations can impose substantial inference cost, both in computation and in memory traffic (e.g., repeatedly fetching weights and intermediate tensors). Specialized accelerators can improve throughput, but practical deployments often remain constrained by power budgets, memory bandwidth, thermal limits, and/or end-to-end latency. These constraints can be especially pronounced in first-layer and other early-layer feature extraction on structured inputs, where large volumes of raw input data are processed across many local regions or receptive fields and where arithmetic cost and memory traffic can dominate overall inference overhead. Moreover, in some applications, including safety-critical or regulated applications, there is growing interest in models that are more interpretable and/or more amenable to verification, auditing, and deterministic execution. In other applications, when using otherwise efficient implementations, input feature preprocessing often becomes an expensive component (e.g., in low-latency applications like particle detection, classification in trigger systems, tick-to-trade use cases, and the like). In some conventional systems, a binary neural network is used, but the first layer requires full-precision float operations, making a (small) first layer the most expensive computational component in the full system.

As a result, a variety of approaches have been explored to reduce inference cost, including model quantization, binary-weight networks, binary activations, and structured sparsity. In the broader class of binary neural networks, for example, an abstraction based on neural-network layers is retained, but representations are constrained and/or quantized to reduce compute and improve hardware efficiency. However, even when weights and activations are quantized, many systems still rely on neural-network abstractions that are ultimately compiled, translated, or otherwise mapped into executable logic, thereby imposing additional complexity and overhead. In contrast, it may be advantageous to construct efficient feature extractors more directly, for example, by determining feature directions from data, quantizing such feature directions to hardware-friendly sets, deriving thresholded and/or integer-valued features therefrom, and synthesizing corresponding feature extractor circuitry for deployment in hardware. For example, the processes described herein may be used to deploy a feature extractor in a field-programmable gate array (FPGA) and/or used to manufacture an application-specific integrated circuit (ASIC).

Structured inputs such as images, videos, and other spatial or temporal data have historically benefited from architectures that exploit structure in the underlying signals, such as convolution and pooling. Conventional CNNs rely on local receptive fields, structured parameter sharing, and pooling operations to efficiently capture translational invariance and local spatial patterns. More generally, many high-performing inference systems benefit from mechanisms that extract informative local or regional features while controlling arithmetic complexity and memory usage.

In many practical deployments, it is not sufficient merely to execute inference in hardware; rather, it is important to achieve high model quality at an acceptable hardware cost. The cost of feature-extractor hardware can be measured in various ways (e.g., the total number of arithmetic operations, additions, gates, bit shifts, circuit area, power consumption, latency, resource utilization, etc.). In at least some contexts, the number of logic gates or binary operations can serve as an approximate proxy for hardware cost, because gate counts relate to chip area and can correlate with transistor count for ASIC implementations or resource utilization for FPGA implementations.

Accordingly, there remains a need for improved systems, methods, and computer-readable media for constructing efficient feature extractors. By way of example and without limitation, desirable improvements include: (i) achieving improved feature quality and/or inference quality for a given hardware cost, (ii) improving the handling of structured inputs such as images, videos, and other spatial or temporal data, (iii) enabling low-precision, integer-valued, and/or Boolean feature generation, (iv) improving shared-arithmetic implementations that reduce redundant computation across multiple feature extractors, and (v) enabling efficient, deterministic, low-latency deployment of feature extraction circuitry on hardware such as FPGAs and ASICs. There remains a need for approaches that directly construct and synthesize feature extractors in forms that are amenable to practical hardware implementation while preserving useful representational power and controllable implementation cost.

In some embodiments, a computing system receives or accesses a dataset and constructs one or more feature extractors from it for use in inference. A feature extractor may be based on one or more feature directions determined from the dataset, where a feature direction may be represented as a vector, tensor, kernel, coefficient arrangement, or other collection of values corresponding to dimensions of a feature extractor input. In some embodiments, the dataset may comprise or be transformed into a dataset of feature-extractor inputs, such as vectors formed from local regions, patches, receptive fields, subsets of features, subsets of channels, or other structured portions of the input data. The input data may comprise images, video, spatial data, temporal data, sensor data, activations, embeddings, or other structured inputs.

In some embodiments, any reference herein to a “channel” is not limited to semantic channels of a multi-channel signal, such as red, green, and blue color channels. More generally, a channel may refer to any respective input signal, input signal component, or input signal dimension presented to a feature extractor, including one or more semantic channels, one or more spatial positions within a kernel, patch, one or more temporal positions within a sequence or time window, or combinations thereof. For example, an input patch of size 3×2×4 may comprise three signal channels over a spatial extent of 2×4. The 3×2×4 input patch may be represented as twenty-four (24) channels or other input signal dimensions for purposes of feature extraction, coefficient assignment, quantization, shared arithmetic analysis, and/or hardware implementation.

In some embodiments, a feature direction is determined by applying one or more decomposition or factorization techniques to a dataset, including singular value decomposition, principal component analysis, eigendecomposition, or other operations that identify directions associated with variance, singular values, eigenvalues, sensitivity, or other informative structure in the data. In some embodiments, a dataset may be centered or otherwise normalized before feature-direction determination. In some embodiments, a feature direction may instead or additionally be derived from parameters of a trained model, such as weights extracted from a trained neural-network layer. Once determined, a feature direction may be quantized to produce a quantized feature direction. In some embodiments, quantization maps entries of the feature direction to a restricted or finite set of values, including integer values and sets that include zero. In some embodiments, the restricted set may comprise the values {−2, −1, 0, 1, 2}. In some embodiments, the quantization may be biased toward values associated with lower hardware implementation cost, including bias toward zero.

In some embodiments, after a quantized feature direction is produced, a dataset is modified by removing the contribution corresponding to the quantized feature direction, rather than removing the contribution corresponding to the feature direction prior to quantization. In some embodiments, for each data point in the dataset, an activation may be computed as the inner product of the data point with the quantized feature direction, and the outer product of the activation with the quantized feature direction may be subtracted from the data point. In this manner, a modified dataset may retain residual error introduced by quantization. In some embodiments, feature directions are determined, quantized, and used to repeatedly update the dataset, generating a plurality of quantized feature directions. In some embodiments, the process may be repeated at least four times. In some embodiments, the modified dataset may be further augmented with outputs from previously generated feature extractors. In some embodiments, feature extractors may be arranged in multiple levels, such that outputs of a first level are used to construct a subsequent dataset from which additional feature directions are obtained. In some embodiments, precision of intermediate feature representations may be reduced, for example, by omitting least significant bits or applying non-linear quantization.

In some embodiments, a quantized feature direction is used to generate one or more activation values from an input vector and to define one or more feature outputs. In some embodiments, an activation distribution is computed by applying the quantized feature direction to a dataset, and one or more thresholds are determined from the activation distribution. In some embodiments, the thresholds comprise one or more quantile thresholds or a plurality of quantile thresholds. In some embodiments, the thresholds comprise one or more thresholds constructed based on a function of the quantile distribution or on a function of the cumulative distribution function of the transformed data. In some embodiments, a feature extractor produces Boolean, multi-bit, or integer-valued outputs by comparing one or more activation values to one or more thresholds. In some embodiments, a plurality of threshold-comparison bits may be summed and offset-adjusted to produce an integer-valued output. In some embodiments, a bit-omission parameter specifies a number of least significant bits to omit to form an integer-valued feature output. In some embodiments, the feature extractors may operate on real-valued inputs, integer-valued inputs, or inputs quantized from real-valued representations.

In some embodiments, one or more quantized feature directions are improved using an optimization or search procedure. In some embodiments, an initial quantized feature direction is treated as a current quantized feature direction, and one or more candidate quantized feature directions are generated by perturbing entries of the current quantized feature direction or by assigning values from a restricted set of integer values. In some embodiments, candidate quantized feature directions are evaluated with respect to an objective that includes a fidelity measure and a hardware implementation cost, or a proxy thereof. Fidelity may be based on activation values, thresholded outputs, Boolean outputs, integer-valued outputs, or combinations thereof. Hardware implementation cost may be based on one or more of gate count, chip area, power consumption, critical path latency, number of addition operations, count of nonzero entries, sum of nonzero bits, or other hardware-relevant measures. In some embodiments, search procedures may include greedy perturbation, stochastic perturbation, random sampling, population-based search, evolutionary search, crossover, mutation, selection, simulated annealing, or other search techniques. In some embodiments, different numbers of feature extractors may be allocated across different patch sizes or receptive-field sizes according to a hardware-cost budget.

In some embodiments, a shared hardware implementation is constructed across a plurality of feature extractors. In some embodiments, coefficients of multiple feature extractors are analyzed over a common set of input channels or over respective overlapping sets of input channels. A selected tuple, including a selected pair in some embodiments, may be identified based on a sharing criterion, such as identical nonzero coefficients or proportional nonzero coefficients assigned by multiple feature extractors. In some embodiments, a merged channel is created to represent a sum or weighted sum of the selected input channels, and feature extractors are modified to reference the merged channel rather than the original tuple. In some embodiments, shared partial sums or other intermediate results are routed to two or more feature extractors. In some embodiments, the channel merging is restricted under consideration of routing, routability and/or respective fan-outs. For example, in some embodiments, it may be favorable for a partial sum that is used many times downstream at distinct physical locations to be computed multiple times in hardware, respectively. In some embodiments, the sharing process iterates over previously created merged channels as candidates for further merging until a termination condition is met. In some embodiments, restricted coefficient sets and repeated coefficient patterns facilitate such shared-arithmetic constructions.

In various embodiments, coefficients are described herein as being defined over, assigned to, or analyzed across input channels. The input channels may correspond to any of the input signal dimensions described herein. Thus, a selected tuple or pair of input channels may comprise semantic channels of a multi-channel signal, spatial positions within a kernel or patch, entries of a feature extractor input vector, temporal positions, feature indices, or combinations thereof. Accordingly, merged channels and shared partial sums are not limited to operations across conventional “channels,” but may also, in some embodiments, be performed across, without limitation, spatially distributed, temporally distributed, or otherwise-structured input signal dimensions.

In some embodiments, the constructed feature extractors are synthesized into hardware representations and/or implemented in digital circuitry. A hardware implementation may include input circuitry configured to receive an inference input and form a feature extractor input vector, feature extraction circuitry configured to compute activation values according to quantized feature-direction vectors, shared arithmetic circuitry including one or more partial-sum computation units, and feature output circuitry configured to generate one or more feature outputs according to feature-output mapping parameters. In some embodiments, parameter storage stores one or more quantized feature-direction vectors, threshold values, distribution-based thresholds, quantile thresholds, quantile-based thresholds, bit-omission parameters, merged-channel definitions, or other parameters, and the circuitry may be reconfigurable by loading updated parameter values from the parameter storage. In some embodiments, fixed representations, combinational-logic netlists, configuration data, or other synthesis-ready representations are generated for implementation in field-programmable gate arrays, application-specific integrated circuits, or other programmable or custom digital hardware. Unless expressly stated otherwise, references herein to a “combinational-logic netlist,” “static logic,” or “static combinational logic” encompass embodiments in which the combinational operations are realized in a single combinational stage, as well as embodiments in which such operations are partitioned across multiple pipelined stages.

The systems and methods described herein may be implemented in a wide variety of computing environments and are not limited to any particular hardware, software, or network architecture. A “computing system” may include one or more processors (e.g., CPUs, GPUs, microcontrollers, DSPs), accelerators (e.g., NPUs, TPUs), and/or programmable or custom logic (e.g., FPGAs, ASICs), and may further include one or more memories, buses, interconnects, storage devices, and communication interfaces. Any “module,” “engine,” “unit,” “component,” or “block” described herein may be implemented in hardware, software, firmware, or any combination thereof, and may be integrated into a single device or distributed across multiple devices (e.g., across a client device and one or more servers). For example, training operations may be executed in a cloud computing environment, and inference operations may be executed on an edge device, embedded controller, FPGA, and/or ASIC. Further, “memory” and “computer-readable medium” include one or more non-transitory storage media (e.g., RAM, ROM, flash, SSD, HDD, optical media) that store instructions and/or data, including datasets, datasets of feature extractor inputs (DSFEIs), quantized feature directions, thresholds, quantile thresholds, bit-omission parameters, merged-channel definitions, netlists, configuration data, and/or representations of feature extractor circuits.

The figures and the corresponding detailed description are intended to be illustrative and non-limiting. Functional blocks shown in the figures may represent hardware components, software components, data structures, and/or combinations thereof; and boundaries between blocks are exemplary and may be rearranged, subdivided, combined, or omitted in various implementations. Any flowcharts, sequences, or steps described herein (including training iterations and forward/backward passes) are examples and may be performed in different orders, repeated, performed concurrently, and/or performed with additional or fewer steps, unless expressly stated otherwise. As used herein, the terms “comprising,” “including,” and “having” are open-ended and do not exclude additional elements; “or” is inclusive unless the context clearly indicates otherwise; “based on” means “based at least in part on;” and terms such as “first,” “second,” and the like are used merely as labels and do not imply a required order or ranking. Ranges and numerical examples are illustrative, and terms such as “about” and “approximately” encompass variations consistent with the disclosed purpose and the tolerances of a given implementation.

Many existing computing systems, methods, and devices may be used in combination with the systems and methods described herein. Some of the infrastructure that can be used with embodiments disclosed herein is already available, such as general-purpose computers, computer programming tools and techniques, digital storage media, and communication links. A computing device or controller may include a processor, such as a microprocessor, a microcontroller, or logic circuitry. Various technologies, systems, architectures, and applications are relevant to the presently described embodiments. Examples of such technologies, systems, architectures, and applications include, but are not limited to, certain aspects of deep neural networks, image recognition, recommender systems, medical diagnosis, language processing, machine learning inference tasks, time series processing, character recognition, voice detection, multi-modal machine learning models, generative AI, image processing, encoding, decoding, encryption, and the like.

A processor and other processing components may include and/or utilize a special-purpose processing device, such as application-specific integrated circuits (ASIC), programmable array logic (PAL), programmable logic array (PLA), programmable logic device (PLD), field-programmable gate array (FPGA), or other customizable and/or programmable device. A computing device may include a machine-readable storage device, such as non-volatile memory, static RAM, dynamic RAM, ROM, CD-ROM, disk, tape, magnetic media, optical media, flash memory, or other machine-readable storage medium. Various aspects of certain embodiments may be implemented using hardware, software, firmware, or a combination thereof.

The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In many instances, well-known structures, materials, or operations are not shown or described in detail to avoid obscuring aspects of this disclosure.

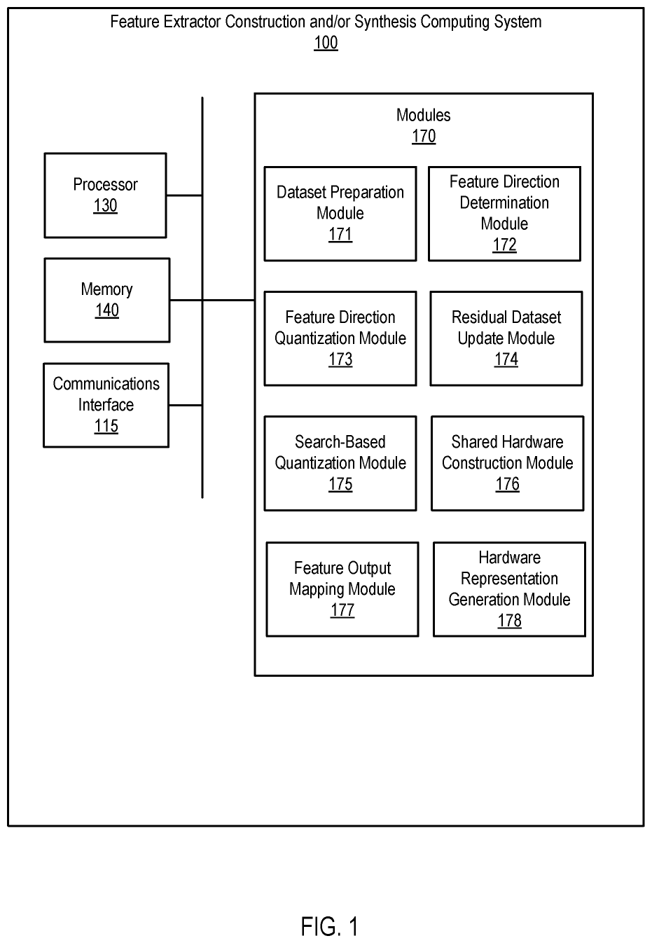

FIG. 1 illustrates an example feature extractor construction and/or synthesis computing system 100 configured to construct quantized feature extractors from one or more datasets and to generate synthesis-ready hardware representations of such feature extractors. In the illustrated example, the computing system 100 may communicate with external devices, storage systems, training systems, synthesis tools, and/or deployment systems via a communications interface 115. The computing system 100 further includes at least one processor 130, a memory 140 coupled to the processor 130, and a collection of executable modules 170 stored in the memory 140 and executable by the processor 130. In some embodiments, the computing system 100 may provide one or more synthesized or synthesis-ready hardware representations to downstream tools or devices via the communications interface 115.

In some embodiments, one or more datasets are provided to or accessed by the computing system 100, for example via the communications interface 115 and/or from local or remote storage accessible to the computing system 100. The datasets may include, by way of example and without limitation, image data, video data, sensor data, feature vectors, activations of one or more upstream models, training examples, labeled or unlabeled samples, and/or any other structured or unstructured data from which feature directions may be derived. In some embodiments, a source of the one or more datasets may comprise a local or remote database, a training-data repository, a file system, a streaming data source, a capture device, or another computing system. In some embodiments, the source of the one or more datasets may be integrated with the computing system 100.

The processor 130 may comprise one or more general-purpose processors, microprocessors, graphics processors, tensor processors, application-specific processors, or other processing circuitry. The memory 140 may comprise any non-transitory computer-readable storage medium, including one or more random-access memories, read-only memories, flash memories, magnetic storage devices, optical storage devices, or other computer-readable media. The modules 170 may be stored in the memory 140 as software instructions, firmware, data structures, configurable logic descriptions, or combinations thereof, and may be executed, interpreted, compiled, or otherwise processed by the processor 130. In some embodiments, one or more of the modules 170 may be implemented in dedicated hardware, programmable logic, or a combination of hardware and software.

In the illustrated example, the modules 170 include a dataset preparation module 171, a feature direction determination module 172, a feature direction quantization module 173, a residual dataset update module 174, a search-based quantization module 175, a shared hardware construction module 176, a feature output mapping module 177, and a hardware representation generation module 178. In some embodiments, the feature direction quantization module 173 performs the quantization operations described herein, and the shared hardware construction module 176 performs one or more shared-arithmetic optimization operations described herein. Although these modules are shown as separate modules for ease of explanation, two or more modules may be combined, subdivided, omitted, replicated, and/or differently arranged in various embodiments.

The dataset preparation module 171 is configured to receive, access, assemble, transform, and/or preprocess one or more datasets used for constructing feature extractors. In some embodiments, the dataset preparation module 171 receives a dataset from the dataset source and constructs a dataset of feature extractor inputs. Such feature extractor inputs may comprise input vectors extracted from a dataset of interest, including local regions, patches, windows, receptive fields, subsets of features, subsets of channels, subsets of dimensions, or other sub-portions of a larger input. For example, for image or video data, the dataset preparation module 171 may extract spatial patches from images or frames, including patches of a single size or multiple different sizes. In some embodiments, the dataset preparation module 171 may generate overlapping or non-overlapping input vectors. In some embodiments, the dataset preparation module 171 may also construct successive datasets for later feature-extractor levels, such as by applying a first level of feature extractors to data derived from an original dataset to generate intermediate feature representations and then constructing a second dataset from the intermediate feature representations.

In some embodiments, the dataset preparation module 171 further performs preprocessing operations on incoming data. For example, the dataset preparation module 171 may quantize real-valued inputs to integer-valued representations, including uniform or non-uniform quantization and non-linear quantization. In some embodiments, the dataset preparation module 171 may reduce the precision of intermediate feature representations, for example, by omitting one or more least significant bits and/or by applying additional non-linear quantization before construction of a subsequent dataset. In some embodiments, the dataset preparation module 171 may prepare multiple datasets or multiple subsets of a dataset corresponding to different patch sizes, receptive fields, channels, or feature subsets, for example, to support allocation of different numbers of quantized feature extractors to different input granularities subject to a hardware-cost budget.

The feature direction determination module 172 is configured to determine one or more feature directions from a dataset, including a dataset prepared by the dataset preparation module 171. In some embodiments, a feature direction determined by the feature direction determination module 172 is a vector or tensor comprising at least two components. In some embodiments, the feature direction determination module 172 determines a feature direction by applying a decomposition to a dataset of feature extractor inputs, such as a decomposition that identifies the direction of greatest variance, the direction associated with the greatest singular value, and/or the direction associated with the greatest eigenvalue. In various embodiments, the decomposition may comprise singular value decomposition, principal component analysis, eigendecomposition, or another decomposition or factorization technique. In some embodiments, the direction may be derived entropically, or as a function of the input data jointly with one or more prediction variables. In some embodiments, the feature direction determination module 172 centers a dataset, for example, by subtracting the mean from each input dimension, prior to determining a feature direction. In some embodiments, the feature direction determination module 172 instead or additionally determines a feature direction by extracting a trained weight vector from a layer of a neural network trained on the dataset or on a related dataset.

The quantization module 173 is configured to quantize feature directions determined by the feature direction determination module 172, producing quantized feature directions. In some embodiments, the quantization module 173 maps entries of a feature direction to a restricted or finite set of integer values, including sets that include zero. In some embodiments, the restricted set may comprise values selected to facilitate hardware implementation, for example, values having a limited number of nonzero bits in their binary representation, values implementable without a hardware multiplier, and/or values biased toward zero. In some embodiments, the restricted set comprises the set {−2, −1, 0, 1, 2}. By way of example, in some embodiments, the restricted set comprises the set {−4, −2, −1, 0, 1, 2, 4} to increase the dynamic range of the computations at a minor additional cost. In some embodiments, by way of example, the restricted set comprises the set {−4, −3, −2, −1, 0, 1, 2, 3, 4} to further increase the precision of the computations at an additional cost. In some embodiments, the restricted set comprises {−N, . . . −1, 0, 1, . . . , N} for some finite positive integer N, optionally with an additional restriction such as that there may be only less than M unique coefficients in a feature extractor for some finite positive integer N<2*M. For example, as long as a coefficient is shared by sufficiently many input dimensions, the exact coefficient may be a minor hardware cost component, when aggregating the inputs by coefficient first, and wherein the coefficient itself may only affect later stages of computation. In some embodiments, the quantization module 173 applies a rounding function biased toward lower hardware implementation costs, including a bias toward zero. The quantization module 173 may also enforce coefficient constraints intended to reduce gate count, chip area, power, latency, or arithmetic complexity in a later hardware implementation.

The residual dataset update module 174 is configured to modify a dataset based on a quantized feature direction produced by the quantization module 173. In some embodiments, the residual dataset update module 174 removes from a dataset a contribution corresponding to a quantized feature direction rather than removing a contribution corresponding to the corresponding feature direction prior to quantization, thereby producing a modified dataset that retains residual error introduced by quantization. In some embodiments, for each data point in the dataset, the residual dataset update module 174 computes an activation, for example, by taking the inner product of the data point with the quantized feature direction, and subtracts from the data point the outer product of the activation with the quantized feature direction. In this manner, the residual dataset update module 174 may remove a projection onto a subspace defined by the quantized feature direction rather than by the original, pre-quantized feature direction. Because the quantized feature direction may define a subspace that differs from the subspace defined by the pre-quantized feature direction, the modified dataset may retain components that would otherwise have been removed, thereby permitting subsequently determined feature directions to compensate, at least in part, for quantization-induced subspace deviation. In some embodiments, the quantization may be performed while considering a variance and/or uncertainty of a feature direction. For example, a feature direction may have a variance, and elements with high variance may be quantized more aggressively to a component with a lower precision, while elements with lower variance may be quantized less aggressively to a higher precision.

In some embodiments, the residual dataset update module 174 is further configured to augment a modified dataset using outputs of previously identified quantized feature extractors. For example, the residual dataset update module 174 may append one or more output activations, bits, or feature values of previously identified quantized feature extractors as additional elements of one or more data points in a modified dataset. In some embodiments, the processor 130 causes the computing system 100 to iteratively apply the feature direction determination module 172, the quantization module 173, and the residual dataset update module 174 to generate multiple quantized feature directions, including embodiments in which at least four iterations are performed to generate at least four quantized feature directions.

The search-based quantization module 175 is configured to improve or optimize quantized feature directions with respect to one or more objectives. In some embodiments, the search-based quantization module 175 receives an initial quantized feature direction from the quantization module 173, sets the initial quantized feature direction as a current quantized feature direction, generates one or more candidate quantized feature directions, evaluates respective candidate quantized feature directions according to one or more objective functions, and selectively replaces the current quantized feature direction with a candidate quantized feature direction that improves the objective. In some embodiments, candidate quantized feature directions are generated by perturbing one or more entries of the current quantized feature direction with different values from a restricted set of integer values. In some embodiments, the search-based quantization module 175 instead or additionally generates candidates using stochastic perturbation, random sampling, population-based search, evolutionary search, crossover, mutation, selection, simulated annealing, or other search procedures.

In some embodiments, the objective function used by the search-based quantization module 175 comprises a fidelity measure and a hardware implementation cost, or a proxy for hardware implementation cost. Example fidelity measures include a difference between activation values produced by a candidate quantized feature direction and activation values produced by the corresponding feature direction prior to quantization, and/or a measure of difference between Boolean outputs obtained after quantile thresholding of activations of the candidate quantized feature direction and Boolean outputs obtained after quantile thresholding of activations of the corresponding feature direction prior to quantization. Example hardware implementation cost measures include, without limitation, gate count, chip area estimate, power consumption estimate, critical path latency, number of addition operations needed for implementation as static combinational logic, count of nonzero entries, and sum of nonzero bits in the binary representations of coefficients. In some embodiments, the search-based quantization module 175 also cooperates with the residual dataset update module 174 so that, after a quantized feature direction is optimized, a contribution of that quantized feature direction is removed from the dataset before determination of a subsequent feature direction, thereby retaining residual quantization error and accounting for such error in subsequent determinations. In some embodiments, evaluating the fidelity measure comprises considering a variance and/or uncertainty of a feature direction, or downstream neural network evaluation to consider a sensitivity of a model to the quantization of the features.

In some embodiments, the search-based quantization module 175 further allocates quantized feature extractors across different patch sizes, receptive-field sizes, or dataset subsets subject to a hardware-cost budget. For example, where the dataset preparation module 171 produces datasets of feature extractor inputs corresponding to multiple patch sizes extracted from image or video data, the search-based quantization module 175 may limit the number of quantized feature extractors associated with each patch size in accordance with a hardware budget, such as a gate-count budget, logic-area budget, latency budget, or power budget.

The shared arithmetic optimization module 176 is configured to construct shared hardware implementations across a plurality of feature extractors. In some embodiments, the shared arithmetic optimization module 176 analyzes coefficients of multiple feature extractors over a common set of input channels or over respective overlapping sets of input channels. The shared arithmetic optimization module 176 may identify a selected multi-element tuple of input channels that satisfies a sharing criterion for a plurality of feature extractors, for example, where multiple feature extractors assign identical nonzero coefficient values to the input channels of the tuple or assign proportional nonzero coefficient values to the input channels of the tuple. The shared arithmetic optimization module 176 may then create a merged channel representing a sum or weighted sum of the input channels of the tuple and modify each feature extractor that satisfies the sharing criterion by replacing references to the selected tuple with a reference to the merged channel and adjusting one or more remaining coefficients to account for the replacement.

In some embodiments, the shared arithmetic optimization module 176 iteratively repeats tuple identification, merged-channel creation, and feature-extractor modification using a modified set of feature extractors, including previously created merged channels as candidates for further merging, until a termination condition is met. Example termination conditions include a condition in which no remaining tuple or pair is shared by more than a threshold number of feature extractors, a condition in which a hardware-cost metric ceases to improve, and/or a condition in which a predetermined number of merge iterations has been reached. In some embodiments, the shared arithmetic optimization module 176 operates on selected pairs of input channels as a particular case of the broader tuple framework. In such pair-based embodiments, the shared arithmetic optimization module 176 may select a pair of input channels together with a matching nonzero coefficient value for which the number of feature extractors assigning that matching coefficient value to both input channels is maximized. The shared arithmetic optimization module 176 may then set coefficient entries for the selected pair to zero and introduce a nonzero coefficient entry for a merged channel, thereby reducing the number of nonzero coefficient entries in a feature extractor.

In some embodiments, where proportional nonzero coefficient values are assigned to the selected pair or tuple, the shared arithmetic optimization module 176 may define the merged channel as a base sum and allow individual feature extractors to incorporate proportional scaling through bit-position routing or subsequent addition without instantiating a dedicated multiplier. In some embodiments, the shared arithmetic optimization module 176 particularly benefits from coefficient repetition patterns induced by quantization into a restricted set of integer values. For example, where quantized feature directions are drawn from five or fewer distinct values, coefficient repetition may occur frequently enough that a count of feature extractors sharing a matching coefficient value for at least one pair of input channels exceeds half of the plurality of feature extractors. The shared arithmetic optimization module 176 may exploit such repetition patterns to reduce the total number of arithmetic operations relative to the independent implementation of each feature extractor.

The feature output mapping module 177 is configured to determine output mappings for feature extractors constructed by the modules 171-176. In some embodiments, the feature output mapping module 177 computes an activation distribution by applying a quantized feature direction to a dataset, such as a dataset of feature-extractor inputs, and determines one or more thresholds from the distribution. In some embodiments, the thresholds include one or more quantile thresholds. The feature output mapping module 177 may thereby define a feature extractor configured to produce a multi-bit output by comparing an activation produced from an input using the quantized feature direction against the plurality of quantile thresholds. In some embodiments, the feature output mapping module 177 instead or additionally determines a bit-omission parameter specifying the number of least significant bits to omit from an activation value to form an integer-valued feature output. In some embodiments, the feature output mapping module 177 may also define feature outputs in which a plurality of threshold-comparison bits are summed and offset-adjusted to produce an integer-valued result.

The hardware representation generation module 178 is configured to generate hardware representations corresponding to the feature extractors constructed and optimized by the system 100. In some embodiments, the hardware representation generation module 178 outputs data representing one or more quantized feature directions and/or one or more feature extractor circuits for synthesis into hardware. In some embodiments, the hardware representation generation module 178 outputs a fixed representation, a combinational-logic netlist, configuration data, or another synthesis-ready representation usable to implement the feature extractors in programmable logic or custom integrated-circuit form. For example, the hardware representation generation module 178 may generate a representation suitable for implementation in a field-programmable gate array (FPGA) or an application-specific integrated circuit (ASIC). In some embodiments, the hardware representation generation module 178 may omit input dimensions corresponding to zero-valued coefficients, implement coefficients whose magnitude is a power of two using bit shifting, implement negative coefficients using subtraction, and/or implement non-power-of-two coefficients by combining shifted and unshifted versions of an input value. In some embodiments, the hardware representation generation module 178 may generate output representations that include parameter storage for quantized feature-direction vectors and/or feature-output mapping parameters, thereby permitting a synthesized implementation to be reconfigured by loading updated parameter values. In various embodiments, the hardware representation generation module 178 may generate output representations that do not include parameter storage (or only include partial parameter storage for a subset of parameters), and instead directly simplify the expressions, which may be performed through synthesis or an approximate synthesis process. In some embodiments, bit shifting may be symbolic and represented in the hardware description and/or hardware represented solely through wiring. It is appreciated that, throughout this disclosure, “bit shift” may, in various embodiments, be only implicitly encoded through wiring or connections, e.g., before a logic synthesis process.

In some embodiments, one or more representations generated by the hardware representation generation module 178 are provided to downstream tools or devices. For example, the computing system 100 may provide a combinational-logic netlist, configuration data, or other representation to one or more synthesis, place-and-route, bitstream-generation, or fabrication tools. In some embodiments, the computing system 100 may provide a representation of a digital integrated circuit that includes input circuitry configured to receive an inference input and form a feature extractor input vector, a plurality of feature extraction circuits configured to compute activation values according to respective quantized feature-direction vectors, shared arithmetic circuitry including one or more partial-sum computation units shared by two or more feature extraction circuits, and feature output circuitry configured to generate one or more feature outputs according to feature-output mapping parameters. Thus, the computing system 100 may be used to construct and synthesize feature extractor circuits that are ultimately deployed as digital integrated circuits, such as FPGA- or ASIC-based implementations.

In some embodiments, the modules 170 cooperate to implement a multistage construction flow in which feature directions are determined by the feature direction determination module 172, quantized by the quantization module 173, incorporated into residual-updated datasets by the residual dataset update module 174, optionally improved by the search-based quantization module 175, optionally reorganized for shared arithmetic by the shared arithmetic optimization module 176, provided with output mappings by the feature output mapping module 177, and converted into synthesis-ready representations by the hardware representation generation module 178. The sequence, granularity, and combination of such operations may vary. For example, some embodiments may use the modules 171-174 without the modules 175-176, some embodiments may use the modules 171-176 but omit explicit output mapping, and some embodiments may construct a first level of feature extractors and then use outputs of the first level to construct one or more subsequent levels of feature extractors.

Although FIG. 1 depicts the modules 171-178 as resident within a single computing system 100, in some embodiments, one or more of the modules 171-178 may be distributed across multiple computing systems, servers, accelerators, and/or logic devices communicating via the communications interface 115. Similarly, datasets, downstream tools, storage systems, and/or deployment systems may be external to the computing system 100 in some embodiments and integrated with the computing system 100 in other embodiments. The arrangement shown in FIG. 1 is therefore illustrative rather than limiting.

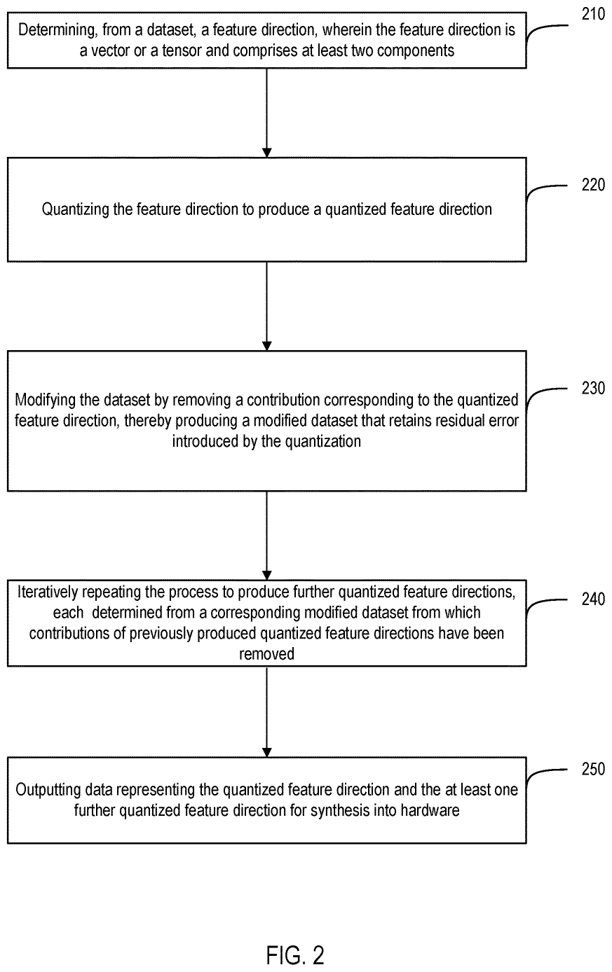

FIG. 2 is a flowchart illustrating an example method for constructing a plurality of quantized feature extractors for synthesis into hardware. In the illustrated example, the flowchart includes steps 210, 220, 230, 240, and 250. In some embodiments, the method of FIG. 2 may be carried out by the feature extractor construction and synthesis computing system 100 of FIG. 1, for example by execution of one or more of the dataset preparation module 171, feature direction determination module 172, quantization module 173, residual dataset update module 174, feature output mapping module 177, and/or hardware representation generation module 178 by the processor 130 using the memory 140.

At step 210, a feature direction is determined from a dataset. In some embodiments, the feature direction is a vector or tensor comprising at least two components. For example, a vector of length 2 may have 2 components, and a matrix of size 2×3 may have 6 components. In some embodiments, the dataset comprises a dataset of feature extractor inputs constructed by extracting, from a dataset of interest, a collection of input vectors, each input vector corresponding to a local region, a patch, or a subset of features of the dataset of interest. In some embodiments, determining the feature direction comprises applying a decomposition that identifies one or more of a direction of greatest variance of the dataset of feature extractor inputs, a direction associated with a greatest singular value of the dataset of feature extractor inputs, a direction associated with a greatest eigenvalue of the dataset of feature extractor inputs, a direction associated with greatest sensitivity, and a direction with the greatest correlation with one or more output variables. In some embodiments, the feature direction may instead or additionally be determined by extracting a trained weight vector from a layer of a neural network trained on the dataset or on a related dataset.

At step 220, the feature direction is quantized to produce a quantized feature direction. In some embodiments, quantization comprises mapping entries of the feature direction to a restricted or finite set of values, such as integer values including zero. In some embodiments, the quantized feature direction has entries selected from the set {−2, −1, 0, 1, 2}. In some embodiments, step 220 comprises applying a rounding function biased toward values associated with lower hardware implementation cost, including a bias toward zero. In some embodiments, such quantization may be selected so that one or more coefficients can be implemented using bit shifts, additions, subtractions, and/or other multiplier-free operations in hardware.

At step 230, the dataset is modified by removing a contribution corresponding to the quantized feature direction, rather than removing a contribution corresponding to the feature direction prior to quantization, thereby producing a modified dataset that retains the residual error introduced by the quantization. In some embodiments, step 230 comprises, for each data point in the dataset, computing an activation by taking the inner product of the data point with the quantized feature direction, and subtracting from the data point the outer product of the activation with the quantized feature direction. In this manner, step 230 may remove from the dataset a projection onto a subspace defined by the quantized feature direction rather than a subspace defined by the feature direction prior to quantization. In some embodiments, because the quantized feature direction defines a subspace different from a subspace defined by the feature direction prior to quantization, the modified dataset retains components that would have been removed had the pre-quantized feature direction been used, such that a subsequent feature direction determined from the modified dataset compensates, at least in part, for quantization-induced subspace deviation of the quantized feature direction. In some embodiments, step 230 further comprises augmenting at least one data point in the modified dataset with at least one additional element representing an output activation of a previously identified quantized feature extractor. In some embodiments, where a dataset comprising input and output pairs is provided, and where a correlation or predictive capability of one or more output variables is used for determining a feature direction, the respective contribution may, alternatively, or, in addition, be removed from the output variable(s).

At step 240, determining, quantizing, and modifying are iteratively repeated to produce at least one further quantized feature direction, each further quantized feature direction being determined from a corresponding modified dataset in which contributions of previously produced quantized feature directions have been removed. In some embodiments, step 240 is repeated at least four times to produce at least four quantized feature directions. In some embodiments, the resulting plurality of quantized feature extractors is used in a hardware implementation of an inference system to process real-valued or integer-valued inputs.

At step 250, data representing the quantized feature direction and the at least one further quantized feature direction is output for synthesis into hardware. In some embodiments, step 250 comprises converting at least one quantized feature direction into a combinational-logic netlist for implementation as static logic on a field-programmable gate array or an application-specific integrated circuit. In some embodiments, input dimensions corresponding to zero-valued entries of the quantized feature direction are omitted from the combinational-logic netlist and entries whose magnitude is a power of two are implemented via bit shifting. In some embodiments, in a first stage, the input variables are first aggregated or summed by common or shared coefficients, and in a second stage, multiplied through bit-shifted addition. In some embodiments, step 250 outputs one or more fixed representations, configuration data, or other synthesis-ready representations corresponding to one or more feature extractor circuits.

Although not separately shown in FIG. 2, in some embodiments the method further comprises computing an activation distribution by applying at least one quantized feature direction to a dataset of feature extractor inputs, determining a plurality of quantile thresholds from the activation distribution, and defining a feature extractor configured to produce a multi-bit output by comparing an activation produced from an input using the at least one quantized feature direction against the plurality of quantile thresholds.

Also, although not separately shown in FIG. 2, in some embodiments the method further comprises constructing a second level of feature extractors. For example, a first level of quantized feature extractors may be applied to data derived from the dataset to produce intermediate feature representations, a second dataset may be constructed from the intermediate feature representations, and steps 210, 220, 230, and 240 may then be performed on the second dataset to obtain a second plurality of quantized feature directions. In some embodiments, precision of the intermediate feature representations is reduced before constructing the second dataset, for example, by omitting least significant bits or by linear or non-linear quantization of the intermediate feature representations. The order of steps shown in FIG. 2 is illustrative. In some embodiments, one or more steps may be combined, subdivided, repeated, omitted, or performed in a different order.

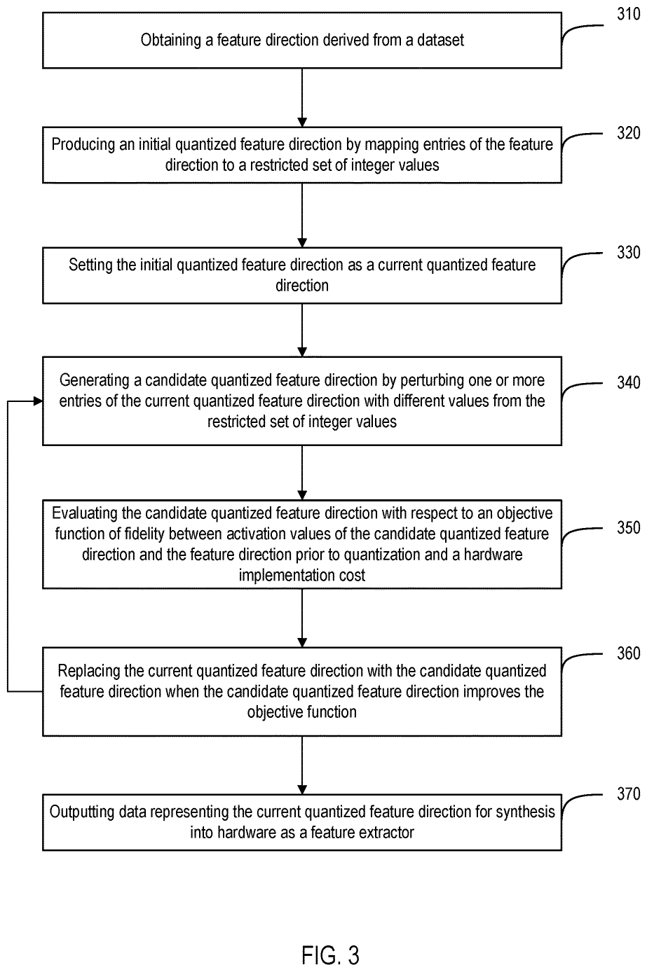

FIG. 3 is a flowchart illustrating an example method for constructing a quantized feature extractor using search-based quantization with a hardware-cost objective. In the illustrated example, the flowchart includes steps 310, 320, 330, 340, 350, 360, and 370. In some embodiments, the method of FIG. 3 may be carried out by the feature extractor construction and synthesis computing system 100 of FIG. 1, including by execution of one or more of the feature direction determination module 172, quantization module 173, search-based quantization module 175, and hardware representation generation module 178.

At step 310, a feature direction derived from a dataset is obtained. In some embodiments, the feature direction is obtained from a trained layer of a neural network. In some embodiments, the feature direction is obtained from a matrix decomposition of the dataset. In some embodiments, the dataset may comprise a dataset of feature extractor inputs generated from image, video, text embedding, embedding, tabular, or time series data, including patches of one or more sizes.

At step 320, an initial quantized feature direction is produced by mapping entries of the feature direction to a restricted set of integer values. In some embodiments, the restricted set is selected to facilitate efficient implementation in static logic. For example, the restricted set may be selected such that each nonzero value has a binary representation with a limited number of nonzero bits or decomposable into a limited number of binary addition/subtraction components, thereby limiting the number of addition operations necessary to implement multiplication by that value in static logic. In some embodiments, the restricted set is further selected so that multiplication of an input by any value in the restricted set can be implemented without a hardware multiplier.

At step 330, the initial quantized feature direction is set as the current quantized feature direction. In some embodiments, step 330 initializes an iterative search or optimization procedure carried out by the search-based quantization module 175. At step 340, a candidate quantized feature direction is generated by perturbing one or more entries of the current quantized feature direction with different values from the restricted set of integer values. In some embodiments, the perturbation changes one coefficient. In some embodiments, the perturbation changes multiple coefficients. In some embodiments, multiple candidate quantized feature directions may be generated in parallel.

At step 350, the candidate quantized feature direction is evaluated with respect to an objective function comprising a fidelity measure and a hardware implementation cost (or a proxy thereof), for a circuit that realizes the candidate quantized feature direction. In some embodiments, the fidelity measure comprises the difference between activation values produced by the candidate quantized feature direction and those produced by the feature direction prior to quantization. In some embodiments, the fidelity measure comprises a measure of the difference between Boolean outputs resulting from quantile thresholding of activations of the candidate quantized feature direction and those resulting from quantile thresholding of activations of the feature direction prior to quantization. In some embodiments, the hardware implementation cost (or proxy thereof) comprises one or more of: (i) a gate count, (ii) a chip area estimate, (iii) a power consumption estimate, (iv) a critical path latency, (v) a number of addition operations used to realize the candidate quantized feature direction as static combinational logic, (vi) a count of nonzero entries in the candidate quantized feature direction, and (vii) a sum of nonzero bits in binary representations of entries of the candidate quantized feature direction.

At step 360, the current quantized feature direction is replaced with the candidate quantized feature direction when the candidate quantized feature direction improves the objective function. In some embodiments, steps 340, 350, and 360 are iteratively repeated until a stopping criterion is met, such as a maximum number of iterations, convergence of the objective function, or failure to improve after a threshold number of candidate evaluations. At step 370, data representing the current quantized feature direction is output for synthesis into hardware as a feature extractor. In some embodiments, the output data may be generated as a combinational-logic netlist, configuration data, or another synthesis-ready hardware representation.

Although not separately shown in FIG. 3, in some embodiments, the method may further comprise removing the contribution of the current quantized feature direction from the dataset from which the feature direction is derived prior to extracting a subsequent feature direction. In such embodiments, the residual error introduced by quantizing the current quantized feature direction is retained in the dataset and accounted for in determining the subsequent feature direction. In some embodiments, the feature direction is derived from a dataset of feature extractor inputs comprising patches of multiple sizes extracted from image or video data, and the number of quantized feature extractors associated with each patch size is limited in accordance with a hardware-cost budget.

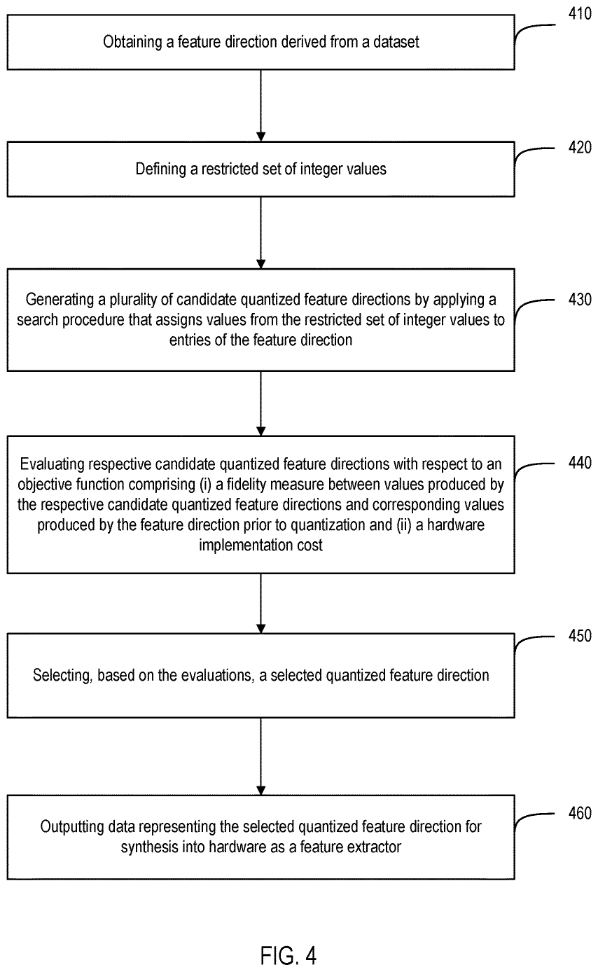

FIG. 4 is a flowchart illustrating another example method for constructing a quantized feature extractor using a search procedure over candidate quantized feature directions. In the illustrated example, the flowchart includes steps 410, 420, 430, 440, 450, and 460. In some embodiments, the method of FIG. 4 may be carried out by the feature extractor construction and synthesis computing system. At step 410, a feature direction is obtained from the dataset (e.g., derived from the dataset). In some embodiments, the feature direction is obtained from a trained layer of a neural network. In some embodiments, the feature direction is obtained from a matrix decomposition of the dataset. In some embodiments, the feature direction is obtained from a sensitivity analysis or correlation analysis of the dataset.

At step 420, a restricted set of integer values is defined. In some embodiments, the restricted set is chosen based on a desired hardware implementation cost, arithmetic simplicity, coefficient sparsity, bit-pattern sparsity, or other implementation-related considerations. At step 430, a plurality of candidate quantized feature directions is generated by applying a search procedure that assigns values from the restricted set of integer values to entries of the feature direction. In some embodiments, the search procedure comprises stochastic perturbation, including random sampling of candidate quantized feature directions. In some embodiments, the search procedure comprises a population-based or evolutionary search that maintains a population of candidate quantized feature directions and applies crossover, mutation, or selection operations to the population. In some embodiments, the search procedure comprises simulated annealing, in which a candidate quantized feature direction with a worse objective value than the current quantized feature direction is accepted with a nonzero probability determined by an annealing schedule.

At step 440, respective candidate quantized feature directions are evaluated with respect to an objective function comprising a fidelity measure and a hardware implementation cost, or a proxy thereof. In some embodiments, the fidelity measure is based on activation values produced by the candidate quantized feature directions and corresponding activation values produced by the feature direction prior to quantization. In some embodiments, the fidelity measure is based on output values derived from activation values, such as thresholded Boolean outputs, integer-valued feature outputs, or both. In some embodiments, the hardware implementation cost reflects arithmetic complexity, gate count, area, power, latency, or another hardware-relevant cost.

At step 450, a selected quantized feature direction is selected based on the evaluations. In some embodiments, the selected quantized feature direction is the candidate quantized feature direction with the “best” objective value according to the objective function (e.g., the highest, lowest, or closest to a target value). In some embodiments, the selected quantized feature direction may be selected after a predetermined number of iterations or after convergence of the search procedure.

At step 460, data representing the selected quantized feature direction is output for synthesis into hardware as a feature extractor. In some embodiments, step 460 comprises outputting data representing a combinational-logic netlist or configuration data for implementation as static combinational logic on a field-programmable gate array or in an application-specific integrated circuit. The order and form of the steps shown in FIG. 4 are illustrative. In some embodiments, candidate generation and evaluation may be repeated, interleaved, parallelized, or adapted according to the selected search procedure.

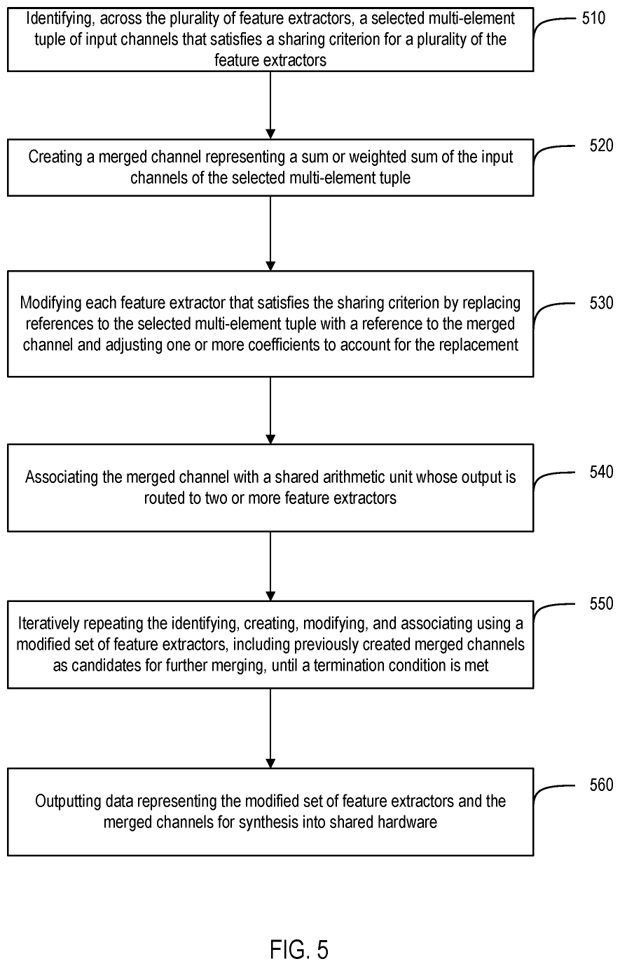

FIG. 5 is a flowchart illustrating an example method for constructing a shared hardware implementation of a plurality of feature extractors. In the illustrated example, the flowchart includes steps 510, 520, 530, 540, 550, and 560. In some embodiments, the method of FIG. 5 may be carried out by the feature extractor construction and synthesis computing system. At step 510, a selected multi-element tuple of input channels is identified across a plurality of feature extractors. In some embodiments, each feature extractor is defined by coefficients over a common set of input channels or respective overlapping sets of input channels. In some embodiments, the selected multi-element tuple satisfies a sharing criterion for a plurality of the feature extractors. The sharing criterion may comprise either: (i) respective feature extractors assigning identical nonzero coefficient values to the input channels of the selected multi-element tuple, or (ii) respective feature extractors assigning proportional nonzero coefficient values to the input channels of the selected multi-element tuple. In some embodiments, the plurality of feature extractors comprises quantized feature extractors obtained by quantizing feature directions derived from a dataset. In some embodiments, the coefficients of the plurality of feature extractors are drawn from a restricted set of integer values, thereby inducing and exploiting coefficient repetition patterns through the sharing process.

At step 520, a merged channel is created representing a sum or weighted sum of the input channels of the selected multi-element tuple. In some embodiments, the merged channel corresponds to a shared arithmetic unit that will later be routed to two or more feature extractors. In some embodiments, for feature extractors that assign proportional nonzero coefficient values to a selected pair of input channels, the merged channel computes a base sum of the selected pair of input channels, and individual feature extractors incorporate proportional scaling via bit-position routing or subsequent addition, without instantiating a dedicated multiplier for proportional scaling.

At step 530, each feature extractor that satisfies the sharing criterion for the selected multi-element tuple is modified by replacing references to the selected multi-element tuple with a reference to the merged channel and adjusting one or more coefficients to account for the replacement. In some embodiments, the selected multi-element tuple comprises a selected pair of input channels. In such embodiments, identifying the selected pair may comprise evaluating coefficient values assigned by the plurality of feature extractors to pairs of input channels and selecting the selected pair together with a matching nonzero coefficient value for which a count of feature extractors assigning the matching nonzero coefficient value to both input channels of the selected pair is maximized. In some embodiments, modifying each feature extractor that assigns the matching nonzero coefficient value to both input channels of the selected pair comprises setting coefficient entries for the selected pair to zero and introducing a nonzero coefficient entry for the merged channel, thereby reducing the number of nonzero coefficient entries in the feature extractor.

At step 540, the merged channel is associated with a shared arithmetic unit whose output is routed to two or more feature extractors. At step 550, the identifying, creating, and modifying are iteratively repeated using a modified set of feature extractors, including previously created merged channels as candidates for further merging, until a termination condition is met. In some embodiments, the termination condition comprises one or more of: no remaining pair of input channels is shared by more than a predetermined number of feature extractors, a hardware-cost metric ceases to improve, or a predetermined number of merge iterations has been reached. In some embodiments, merging may also be skipped without terminating. For example, but not by way of limitation, merging may be skipped when fan-out would become too large, when routing would become too congested, and/or the latency would exceed a certain target latency. At step 560, data representing the modified set of feature extractors and the merged channels is output for synthesis into shared hardware. In some embodiments, step 560 comprises outputting a netlist or configuration data for implementation on a field-programmable gate array or in an application-specific integrated circuit.

In some embodiments, the plurality of feature extractors processed according to FIG. 5 are quantized feature extractors obtained by determining successive feature directions from a dataset, quantizing each feature direction, and removing the contribution of each quantized feature direction from the dataset before determining the next feature direction. As such, the quantization error from each preceding quantized feature direction is retained in the dataset. In some embodiments, the plurality of feature extractors are quantized feature extractors whose coefficients have been iteratively improved by evaluating candidate quantized feature directions with respect to an objective comprising a fidelity measure and a hardware implementation cost, or a proxy thereof. In some embodiments, the restricted set of integer values from which coefficients are drawn comprises five or fewer distinct values. In some embodiments, a count of feature extractors sharing a matching coefficient value for at least one pair of input channels exceeds half of the plurality of feature extractors, thereby making the shared arithmetic optimization particularly advantageous.

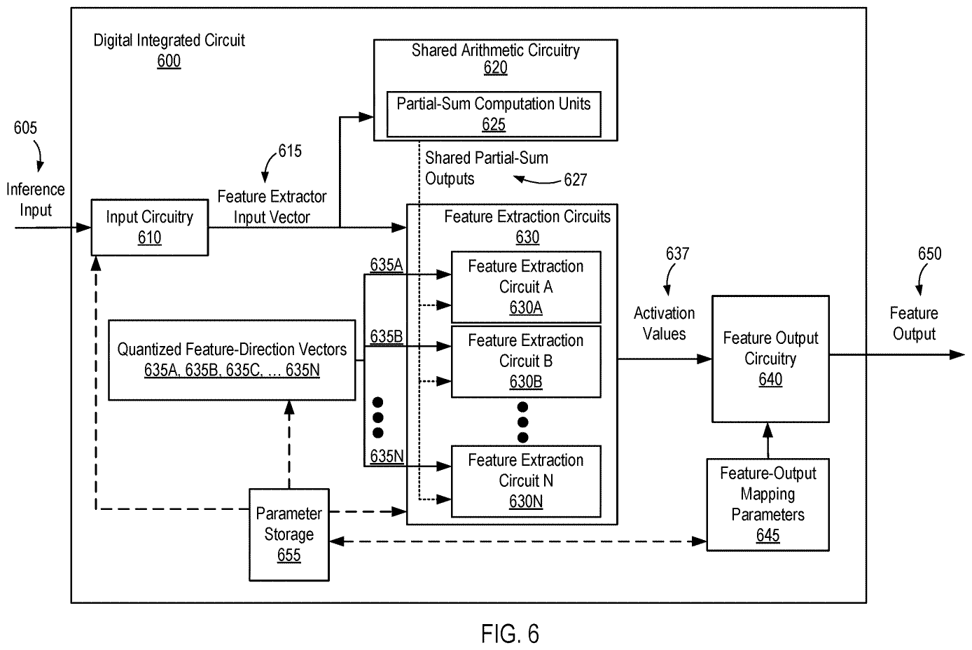

FIG. 6 is a functional block diagram illustrating an example digital integrated circuit 600 configured to implement one or more quantized feature extractors using shared arithmetic circuitry. In the illustrated example, the digital integrated circuit 600 receives one or more inference inputs 605, includes input circuitry 610, shared arithmetic circuitry 620, a plurality of feature extraction circuits 630, feature output circuitry 640, feature-output mapping parameters 645, and one or more feature outputs 650. In the illustrated example, the digital integrated circuit 600 further includes parameter storage 655. In various embodiments, the parameter storage 655 is omitted, and respective parameters may be implicitly encoded in other portions of the integrated circuit. In some embodiments, the digital integrated circuit 600 may be implemented in a field-programmable gate array, as an application-specific integrated circuit, or another form of digital logic circuitry.

The input circuitry 610 is configured to receive the inference input or inputs 605 and to form one or more feature extractor input vectors 615 therefrom. In some embodiments, the inference input 605 comprises an image, a video frame, or another structured input. In some embodiments, the input circuitry 610 extracts a patch corresponding to a receptive field and arranges patch samples into one or more feature extractor input vectors 615. In some embodiments, the input circuitry 610 may additionally perform one or more preprocessing operations, such as channel selection, subset selection, or quantization of input values, before providing the feature extractor input vectors 615 to downstream circuitry. In some embodiments, the input circuitry 610 may additionally perform one or more value preprocessing transformations such as linear or non-linear operations. For example, the input circuitry 610 may normalize the data based on configurable mean and/or standard deviation values, or based on configurable minimum and maximum range parameters.

The feature extractor input vectors 615 are provided to the feature extraction circuits 630 and, in some embodiments, also to the shared arithmetic circuitry 620. In the illustrated example, the shared arithmetic circuitry 620 comprises one or more partial-sum computation units 625. The partial-sum computation units 625 are configured to compute one or more shared partial sums or other intermediate arithmetic values based on subsets of elements of the feature extractor input vectors 615. In the illustrated example, outputs of the partial-sum computation units 625 are provided as shared partial-sum outputs 627. In some embodiments, the shared partial-sum outputs 627 are routed to two or more of the plurality of feature extraction circuits 630. In this manner, the shared arithmetic circuitry 620 may reduce duplication of arithmetic operations across multiple feature extraction circuits.

The plurality of feature extraction circuits 630 comprises respective feature extraction subcircuits, shown in the illustrated example as feature extraction circuit A 630A, feature extraction circuit B 630B, and feature extraction circuit N 630N, with additional feature extraction circuits omitted for clarity. Each of the feature extraction circuits 630A, 630B, . . . , 630N is configured to compute an activation value by accumulating weighted contributions of elements of the one or more feature extractor input vectors 615 according to coefficients of a corresponding quantized feature-direction vector. In some embodiments, the feature extraction circuits 630A-630N receive the shared partial-sum outputs 627 in addition to or instead of directly computing all intermediate values independently.

In the illustrated example, the feature extraction circuits 630 are associated with corresponding quantized feature-direction vectors 635A, 635B, . . . 635N. In some embodiments, each of the quantized feature-direction vectors 635A-635N defines coefficients used by a corresponding one of the feature extraction circuits 630A-630N. In some embodiments, the coefficients are selected from a finite set of integer values, including zero. In some embodiments, zero-valued coefficients correspond to omitted input dimensions. In some embodiments, the coefficients are selected from the set {−2, −1, 0, 1, 2}. In some embodiments, weighted contributions are computed using adders and bit-shift operations without multiplication operations. In some embodiments, multiplication by a power-of-two coefficient is implemented via bit shifting, negative coefficients are implemented using subtraction, and multiplication by a non-power-of-two coefficient is implemented by combining shifted and unshifted versions of an input value.

The feature extraction circuits 630 generate one or more activation values 637, which are provided to the feature output circuitry 640. In some embodiments, each feature extraction circuit produces one or more activation values 637 corresponding to one or more quantized feature-direction vectors 635A-635N. In some embodiments, 635A-635N are partially or fully omitted and may comprise fixed or partially fixed parameters which may be implicitly encoded in their respective feature extraction circuits 630A-630N, and optionally further in the shared arithmetic circuitry 620. In some embodiments, the activation values 637 are scalar values representing accumulations of weighted contributions of elements of the feature extractor input vectors 615.

The feature output circuitry 640 is configured to generate one or more feature outputs 650 from the activation values 637 according to the feature-output mapping parameters 645. In some embodiments, the feature-output mapping parameters 645 comprise a plurality of threshold values. In some embodiments, the feature output circuitry 640 generates a plurality of feature bits by comparing activation values 637 to respective threshold values. In some embodiments, for at least one of the plurality of feature extraction circuits 630, the threshold values correspond to quantiles of an activation distribution obtained by applying a respective quantized feature-direction vector to a dataset of feature extractor inputs used to determine that quantized feature-direction vector. In some embodiments, the feature output circuitry 640 further generates an integer-valued feature output by summing a plurality of feature bits and subtracting an offset value. In some embodiments, the feature output circuitry 640 further generates an integer-valued feature output via a linear or non-linear transformation.

In some embodiments, the feature-output mapping parameters 645 instead, or additionally, comprise a bit-omission parameter specifying a number of least significant bits of an activation value 637 to omit to form an integer-valued feature output. In some embodiments, the feature-output mapping parameters 645 instead, or additionally, comprise configuration parameters for a linear or non-linear configurable transformation. In some embodiments, the feature-output mapping parameters 645 may be omitted. Accordingly, the feature output circuitry 640 may generate Boolean-valued outputs, multi-bit outputs, integer-valued outputs, or combinations thereof as the feature outputs 650.

Some embodiments may comprise a parameter storage 655. In such embodiments, the parameter storage 655 may be configured to store at least one of configuration parameters for the input circuitry 610, the quantized feature-direction vectors 635A-635N, information associated with the quantized feature-direction vectors 635A-635N, and/or the feature-output mapping parameters 645. In some embodiments, a parameter storage may be omitted, and, in such embodiments, parameters may be implicitly encoded in other parts of the integrated circuit. In some embodiments, the parameter storage 655 provides stored parameter values to the feature extraction circuits 630, to the quantized feature-direction vector inputs 635A-635N, to the input circuitry 610, and/or to the feature-output mapping parameters 645. In the illustrated example, dashed lines indicate parameter-storage coupling between the parameter storage 655 and one or more of the quantized feature-direction vectors 635A-635N, the feature extraction circuits 630, and the feature-output mapping parameters 645. In some embodiments, such dashed couplings represent loading, updating, configuring, reconfiguring, or otherwise communicating parameter values. Thus, in some embodiments, the plurality of feature extraction circuits 630 and/or the feature output circuitry 640 may be reconfigurable by loading updated parameter values from the parameter storage 655. Moreover, updated parameters may be loaded into the parameter storage from an external source or, in some embodiments, during operation by other subcircuits of the digital integrated circuit 600.

In some embodiments, the shared arithmetic circuitry 620, the feature extraction circuits 630, the feature output circuitry 640, and the parameter storage 655 cooperate to implement a bank of quantized feature extractors within the digital integrated circuit 600. In some embodiments, the feature extraction circuits 630A-630N correspond to quantized feature-direction vectors 635A-635N obtained from decomposition-based feature-direction construction, neural-network-derived feature directions, search-based quantization, residual-error-retaining feature-direction generation, shared-arithmetic optimization, or combinations thereof.

In some embodiments, at least one of the quantized feature-direction vectors 635A-635N corresponds to a quantized version of a singular vector, an eigenvector, or a principal component obtained from a dataset of feature extractor inputs. In some embodiments, the dataset of feature extractor inputs is centered by subtracting, for each input dimension, a mean value prior to obtaining the singular vector, the eigenvector, or the principal component. In some embodiments, multiple feature extraction circuits 630A-630N are based on quantized feature directions obtained successively by determining feature directions from a dataset, quantizing the feature directions, and removing contributions corresponding to previously quantized feature directions from the dataset while retaining residual quantization error.

Although FIG. 6 illustrates one example arrangement of the digital integrated circuit 600, many variations are possible. In some embodiments, one or more blocks may be combined, subdivided, omitted, duplicated, or differently arranged. In some embodiments, one or more of the dashed parameter-storage couplings may be omitted or replaced with direct connections. In some embodiments, the number of feature extraction circuits 630, the number of quantized feature-direction vectors 635A-635N, the number of partial-sum computation units 625, and the number or type of feature outputs 650 may vary according to a selected or target implementation.

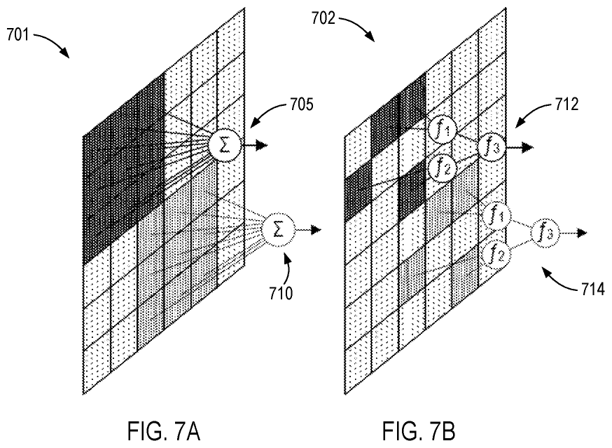

FIGS. 7A and 7B illustrate example arrangements for generating aggregated feature values from spatially distributed or channel-distributed input values. In the illustrated example, FIG. 7A is designated generally by reference numeral 701, and FIG. 7B is designated generally by reference numeral 702. In some embodiments, the arrangements shown in 701 and 702 may be used during the preparation of datasets of feature extractor inputs, during the generation of intermediate feature representations, during the implementation of feature extraction circuitry, and/or during the construction of shared arithmetic structures for the hardware realization of feature extractors.

In various embodiments, the gridded structures shown in 701 and 702 represent an input array, feature map, patch, receptive field, subset of features, subset of channels, or other structured arrangement of input values from which one or more feature-extractor inputs may be derived. Individual cells of the gridded structures may correspond to pixels, pixel values, patch samples, channel values, activation values, or other components of the input vector. The shaded cells may correspond to selected input positions or channel values that participate in computations producing the partial sums 705 and 710 or the merged-channel outputs 712 and 714. The remaining cells may correspond to omitted or zero-weight positions, or positions not participating in a particular computation.

In FIG. 7A, the example arrangement 701 illustrates a direct aggregation of selected values from a structured input region. In the illustrated example, values from a selected region of the gridded structure are provided to one or more summation operations, shown as 2, to produce one or more aggregated outputs (partial sums 705 and 710). In some embodiments, the arrangement 701 corresponds to the direct formation of a feature extractor input or the direct computation of an activation value from a selected local region, patch, or subset of features. In some embodiments, the arrangement 701 may represent an implementation in which multiple selected input dimensions contribute directly to a common summed or accumulated value (e.g., as part of a feature extractor input vector, a partial sum, an activation value, or another aggregated feature quantity).

In FIG. 7B, the example arrangement 702 illustrates a decomposed, hierarchical, and/or partially shared implementation of an aggregation or feature-extraction computation. In the illustrated example, subsets of selected input positions are first processed by intermediate functions labeled f1 and f2, and outputs of such intermediate functions are then combined by a further function labeled f3 to produce a higher-level output (e.g., “merged” channels 712 and 714). In various embodiments, the functions f1, f2, and f3 may represent summation, partial-sum, aggregation, intermediate feature, thresholding-related, or other feature-extraction operations.

In some embodiments, the arrangement 702 supports the construction of multiple levels of feature extractors. For example, outputs of lower-level functions such as f1 and f2 may correspond to intermediate feature representations produced by a first level of feature extractors, while a higher-level function such as f3 may operate on those intermediate feature representations to form a second-level feature representation or activation. In various embodiments, a first level of quantized feature extractors may be applied to data derived from a dataset to produce intermediate feature representations. A second dataset may be constructed from the intermediate feature representations. One or more subsequent feature extractors may be constructed from the second dataset. In some embodiments, the precision of the intermediate feature representations may be reduced prior to higher-level processing, for example, by omitting the least significant bits and/or applying non-linear quantization.

In some embodiments, the lower-level functions f1 and f2 may correspond to shared arithmetic units, merged channels, and/or partial-sum computation units. The outputs thereof may be routed to two or more feature extractors or subsequent combining functions, such as f3. In various embodiments, input channels or subsets of inputs may first be combined into intermediate results and then reused, rather than recomputing all arithmetic independently for each final feature extractor. As such, a selected tuple (e.g., a pair) of input channels may be identified, and a merged channel representing a sum or weighted sum of the selected inputs may be created. Multiple feature extractors may be modified to reference the merged channel. The shared arithmetic may reduce the total number of arithmetic operations and/or the number of gates relative to the independent implementation of each feature extractor.

In various embodiments, the proportional relationships among coefficients may be exploited. For example, a first intermediate function, such as f1 or f2, may compute a base sum of selected inputs. A subsequent function, such as f3, may incorporate scaling, routing, and/or further combination of those intermediate outputs without instantiating a dedicated multiplier for each final computation. In some embodiments, this decomposition is particularly advantageous when feature extractors have coefficients selected from a restricted integer-valued set, resulting in repeated coefficient patterns across multiple feature extractor channels.

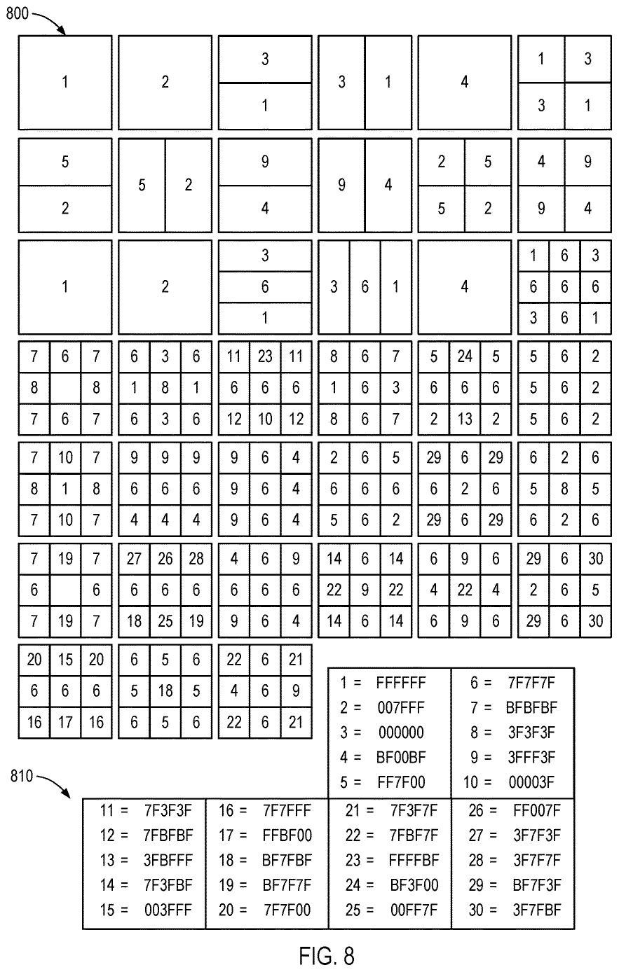

FIGS. 8-13 illustrate example visualizations of quantized feature directions, feature extractor kernels, or feature dimensions constructed according to the methods described herein. FIGS. 8-13 are rendered without color. Accordingly, the boxes 800, 900, 1000, 1100, 1200, and 1300 in the figures are labeled with numerical encodings, and each figure includes an accompanying legend 810, 910, 1010, 1110, 1210, and 1310 that maps these encodings to corresponding hexadecimal color values (or rough approximations thereof). The legends 810-1310 indicate the different color states or color tuples used in the corresponding color renderings. Corresponding color versions of these visualizations are included in one or more of the provisional patent applications to which the present application claims priority.

In the illustrated example, the legends 810, 910, 1010, 1110, 1210, and 1310 map the colors shown in the provisional patent application to hexadecimal values. However, it is appreciated that each color represents RGB feature extractor coefficients. For example, the color black is represented in the hexadecimal legends as 000000, which represents RGB coefficients [−2, −2, −2], (or [−1, −1, −1] in some embodiments).

In some embodiments, the quantized feature directions shown in FIGS. 8-13 are obtained by constructing a dataset of feature extractor inputs (DSFEI) from a dataset of interest, extracting one or more feature directions from the DSFEI (for example, using singular value decomposition, principal component analysis, eigendecomposition, sensitivity analysis, correlation analysis, or another decomposition or analysis), and quantizing the extracted feature directions to a restricted set of values to obtain kernels for efficient feature extractors.

In some embodiments, the DSFEI is formed from local regions, patches, receptive fields, feature subsets, or other structured subsets of the dataset, including image or video patches, tabular data entries, feature subsets of tabular data entries, time-series elements, time-series windows or sub-windows, and embeddings. In some embodiments, the quantized feature directions shown in FIGS. 8-13 may instead, or in addition, be obtained from a trained layer of a neural network and then quantized for efficient hardware implementation. In some embodiments, the quantized feature directions in FIGS. 8-13 are selected from a restricted or finite set of quantization values, such as integer values including zero (e.g., {−2, −1, 0, 1, 2}). In other embodiments, other restricted sets may be used. In some embodiments, the quantization is selected or biased to favor values associated with lower hardware implementation cost, including a bias toward zero, such that inference cost may be reduced by increasing the number of zero-valued entries and/or by favoring values that are efficiently implementable using relatively low-cost operators or circuitry (e.g., shifting, addition, and subtraction operations).

In some embodiments, each box in FIGS. 8-13 corresponds to a spatial position within a patch or kernel and, for multi-channel inputs, may correspond to a tuple (e.g., a pair) of values associated with that position across multiple channels, such as red, green, and blue channels for RGB image data. In the corresponding color visualizations, the rendered color of a box may correspond to a tuple of quantized values. For example, neutral gray may correspond to [0, 0, 0] (Hex: #7F7F7F), black may correspond to [−2, −2, −2] (Hex: #000000), white may correspond to [2, 2, 2] (Hex: #FFFFFF), blue may correspond to [−2, 0, 2] (Hex: #007FFF), and orange may correspond to [2, 0, −2] (Hex: #FF7F00).

FIG. 8 corresponds to a visualization of example feature extractor kernels or feature dimensions for an image data set, in which kernels of size 2×2 are shown in the upper two rows and kernels of size 3×3 are shown in the lower rows. As illustrated, different spatial patch sizes may be used within a common feature-extractor construction framework. In some embodiments, the kernels are suitable for use as first-level feature extractors applied directly to local regions of image or video inputs. In some embodiments, different feature directions may exhibit different spatial patterns and different distributions of quantized values even when quantized to the same restricted set. Some kernels may emphasize edges, directional transitions, localized contrast, or structured color relationships, while other kernels may include more zeros or repeated values to facilitate efficient implementation. In some embodiments, such kernels are produced after standardization and/or quantization of feature directions extracted from a DSFEI. In some embodiments, a plurality of kernels may be successively constructed by repeatedly removing contributions corresponding to previously quantized feature directions from a dataset while retaining residual quantization error. While the visualizations provide example cases of spatial patches, it is appreciated that this is for improved visual understanding, and it is further appreciated that the methods may, as described in this disclosure, be also applied to various other domains.

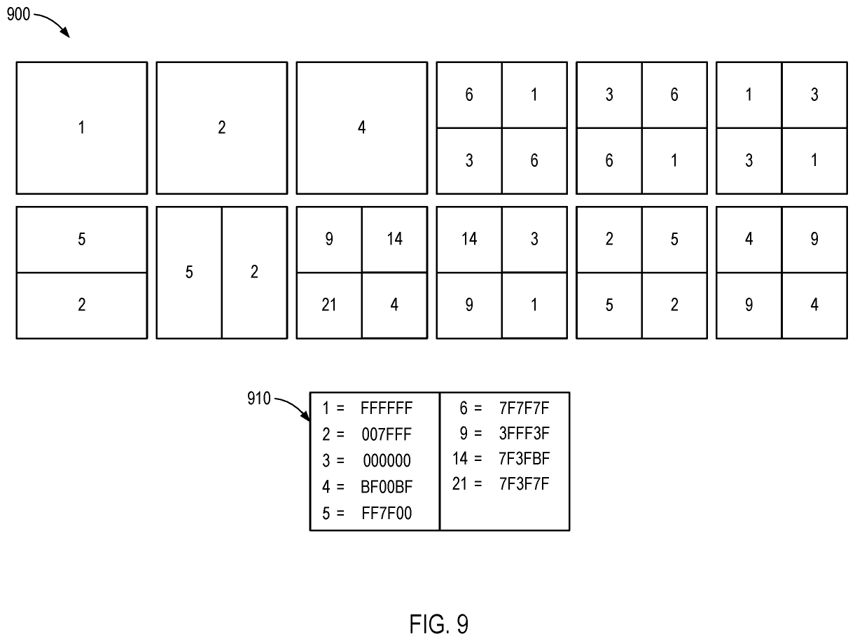

FIG. 9 illustrates example feature extractor kernels or feature dimensions for another image data set and another embodiment of the disclosed systems and methods using a kernel or patch size of 2×2. In some embodiments, the quantized kernels correspond to feature directions derived from a DSFEI, formed by extracting 2×2 patches from the image dataset. In some embodiments, the relatively small patch size supports low-cost or early-stage feature extraction, including implementations in which a plurality of small kernels are used to capture local spatial or color structure at low arithmetic cost.

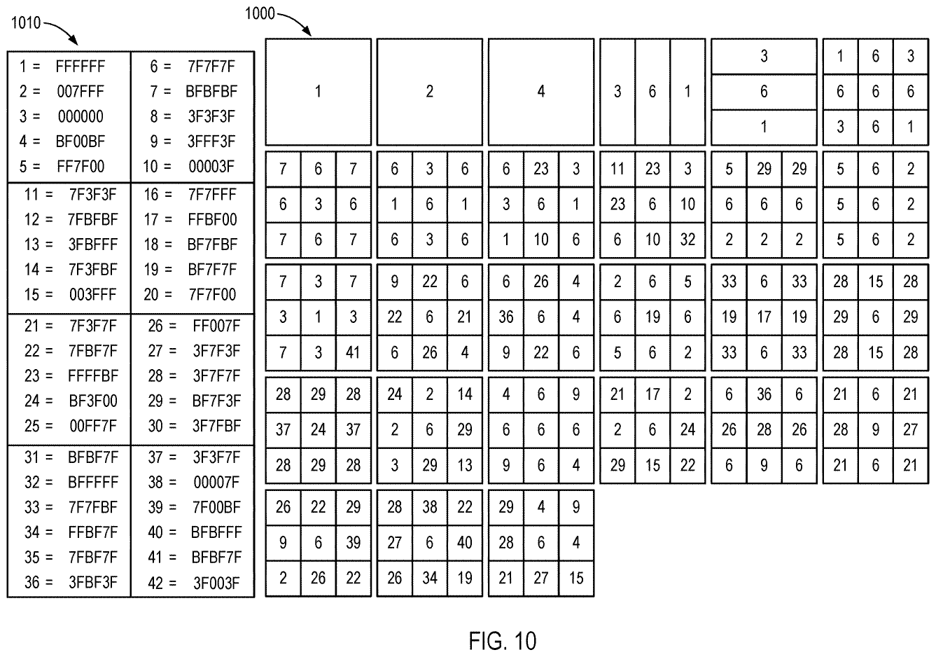

FIG. 10 illustrates example feature extractor kernels or feature dimensions for the same or another image data set using a kernel or patch size of 3×3. In some embodiments, the larger patch size permits the feature directions to capture more spatial context, more complex local correlations, and/or richer channel combinations. In some embodiments, the kernels shown in FIG. 10 may have a greater hardware cost than the kernels shown in FIG. 9, but may also provide improved expressiveness or accuracy for certain inputs. Combinations of the feature extractor kernels or feature dimensions from FIGS. 9 and 10 may be combined and selected based on a target trade-off among hardware cost, arithmetic complexity, input precision, and overall inference accuracy.

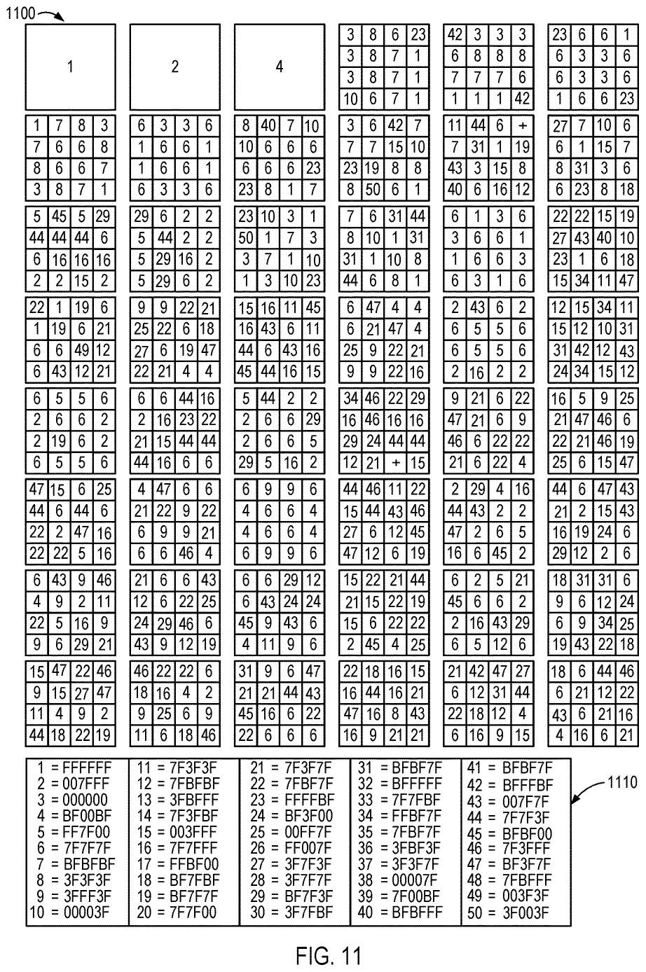

FIG. 11 illustrates example feature extractor kernels or feature dimensions for an image data set using a kernel or patch size of 4×4. As illustrated, the same quantization and feature-direction construction techniques may be applied to higher-dimensional feature extractor inputs corresponding to larger spatial patches. In some embodiments, larger kernels may be more expensive to implement and therefore may be used in fewer numbers or selected based on hardware-cost goals or targets.

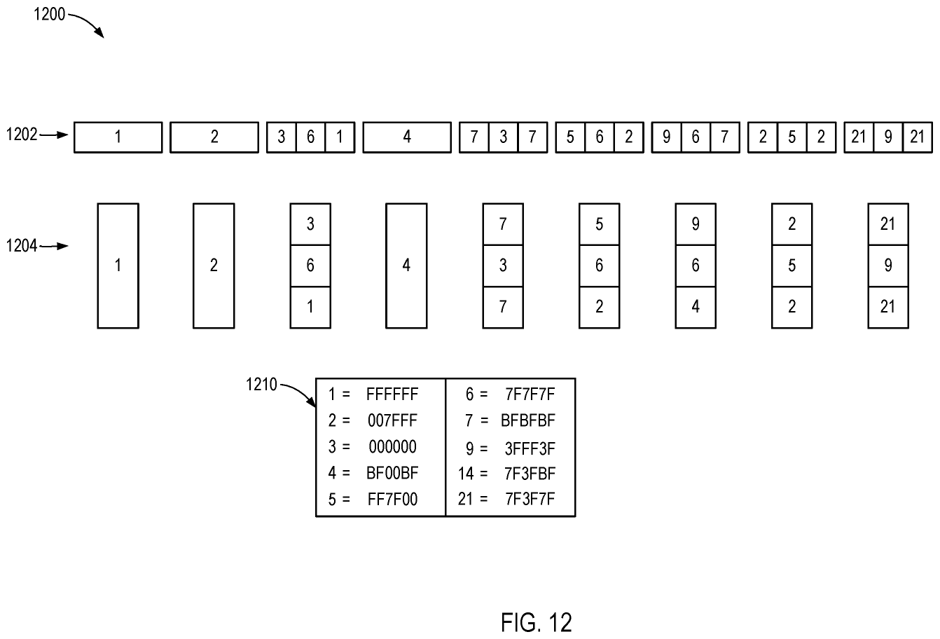

FIG. 12 illustrates example feature extractor kernels or feature dimensions for an image data set using anisotropic kernel or patch sizes of 3×1 in a first row 1202 and anisotropic kernel or patch sizes of 1×3 in a second row 1204. In some embodiments, the kernels may be implemented to capture directional or orientation-specific patterns, such as horizontal structure, vertical structure, directional transitions, or elongated local relationships. In some embodiments, the use of anisotropic kernels enables the construction of feature extractors specialized for directional patterns while maintaining an efficient arithmetic structure.

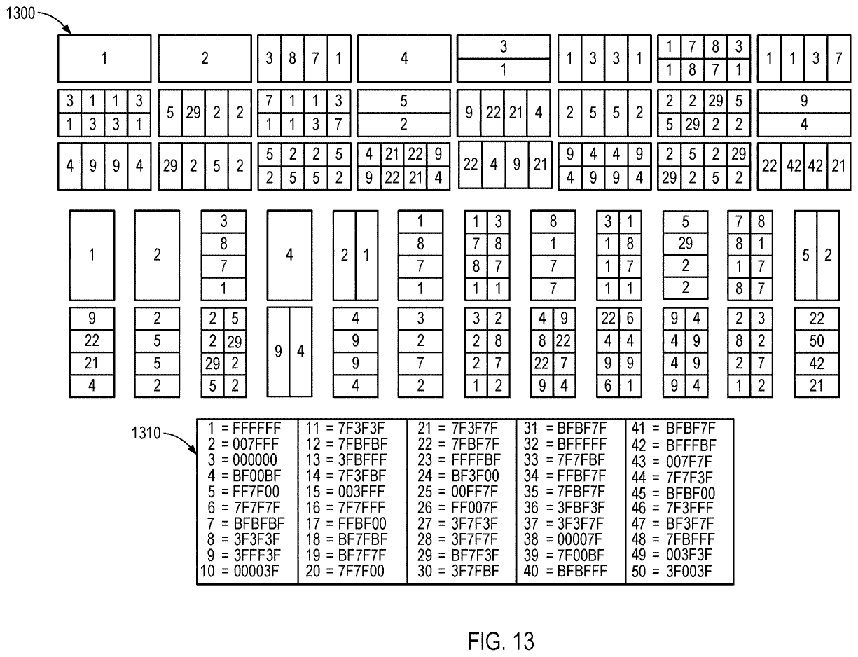

FIG. 13 illustrates example feature extractor kernels or feature dimensions for an image data set using anisotropic kernel or patch sizes of 4×2 and 2×4. In some embodiments, the kernels may be elongated or rectangular feature directions that capture patterns extending across different spatial extents and orientations. In some embodiments, the kernels may be selected as part of a mixed-size feature extractor bank in which smaller, larger, isotropic, and anisotropic kernels are combined to improve expressiveness while controlling hardware cost. In some embodiments, the receptive field may be deviating from a rectangular shape. For example, certain input pixels may be additionally included or omitted.

According to various embodiments, the kernels illustrated in FIGS. 8-13 provide simplified examples of kernels that can be efficiently implemented in hardware. For example, for groups of input dimensions having equal values in a given quantized feature direction, sums may be computed using adders. Coefficients whose magnitudes are powers of two may be incorporated using bit shifting. Negative signed entries may be handled using subtraction. If a coefficient is not itself a power of two, a multiplication may be implemented by combining shifted and unshifted versions of an input value. In some embodiments, zero-valued entries may be omitted from a logic netlist. In some embodiments, the kernels and their associated thresholds and/or divisors may be implemented as static or fixed logic gates or other fixed logic operators in an FPGA or ASIC.

In some embodiments, any of the illustrated kernels may be used as first-level feature extractors applied to an original dataset or DSFEI. Outputs of the first-level feature extractors, including integer-valued outputs, may then be used to construct a second dataset from which a second set of quantized feature directions can be obtained. In some embodiments, the precision of such intermediate feature representations may be reduced, for example, by removing the least significant bits, optionally removing the most significant bit to avoid overflow, by thresholding, by multiplication with a scalar followed by quantization, and/or adding or subtracting an offset.

In some embodiments, the kernels may be used as initial quantized feature directions in a search-based quantization or optimization process. For example, an initially quantized feature direction may be iteratively improved by perturbing one or more entries, evaluating candidate quantized feature directions with respect to fidelity and hardware implementation cost, and accepting a candidate when it improves an objective function. In some embodiments, fidelity may be measured using (i) differences between activation values, (ii) divergence or difference measures between Boolean thresholded outputs, or (iii) both. In some embodiments, hardware cost may be measured or proxied by chip area, power draw, latency, gate count, number of additions, nonzero count, or number of nonzero bits. In some embodiments, the patterns shown in the kernels of FIGS. 8-13, including repeated values and zero-valued entries, may result from or be intentionally obtained using the optimization processes described herein.

In some embodiments, repeated structures or repeated quantized patterns may be exploited in shared-hardware implementations. For example, if multiple kernels share common tuples or pairs of input-channel contributions, clustering or discrete optimization may be used to merge channels or to perform shared partial-sum computations. In some embodiments, such simplifications may be performed explicitly by a construction algorithm or implicitly by a synthesis tool. In some embodiments, real-valued inputs used to generate or apply the kernels may first be quantized to integer-valued representations. The quantization may be linear or non-linear, and/or the construction of the quantized feature directions may be adjusted according to the quantization scheme. In some embodiments, a tradeoff may be selected between input precision and overall hardware efficiency.

Accordingly, FIGS. 8-13 are not merely provided as visual illustrations of specific kernels, but rather as examples of the broader class of quantized feature directions that may be constructed from structured inputs, quantized for low-cost implementation, thresholded for Boolean and/or multi-bit feature generation, converted to integer-valued outputs, synthesized into hardware, optimized with respect to fidelity and cost, arranged across multiple patch sizes, stacked into multiple levels, and/or co-implemented through shared arithmetic structures. The specific box patterns and the numerical encodings corresponding to specific colors are illustrative and are provided as non-limiting examples.

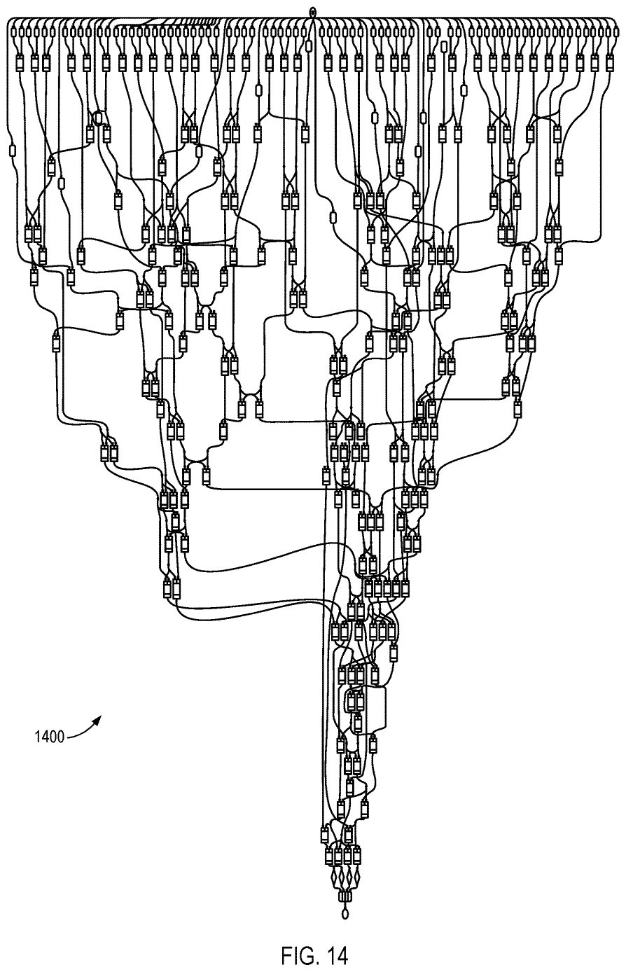

FIG. 14 illustrates an example synthesized hardware representation 1400 of a feature extractor circuit. In some embodiments, the representation 1400 may be considered a graph or schematic visualization of a combinational-logic netlist corresponding to a quantized feature extractor constructed according to one or more of the methods described herein. In some embodiments, the netlist is generated from a quantized feature direction and associated feature-output mapping parameters after construction, quantization, and optional optimization, and is provided as a synthesis-ready hardware representation for implementation in programmable logic or a custom integrated circuit.

In some embodiments, the netlist represents a gate-level or logic-level realization of a feature extractor configured to receive a plurality of input bits corresponding to a quantized input vector, such as a patch, receptive field, or other structured input, and to generate one or more output bits or other output values. In some embodiments, the logic is purely combinational and realizes weighted contributions using additions, subtractions, bit shifts, and other Boolean or arithmetic operations. In some embodiments, zero-valued coefficients are omitted from the synthesized logic; coefficients with magnitudes that are powers of two are implemented using bit shifting; and other coefficients are implemented using combinations of shifted and unshifted values.

In some embodiments, the netlist further implements feature-output mapping, such as threshold-based generation of Boolean or multi-bit features and/or formation of integer-valued outputs using bit omission and/or offsetting. As exemplified in the representation 1400, a quantized feature extractor may be reduced to a concrete, synthesizable hardware structure. The particular netlist topology is illustrative only and intended to provide a simplified visual example.

Clause 1: In some embodiments, a computer-implemented method for constructing a quantized feature extractor for synthesis into hardware comprising: obtaining a feature direction derived from a dataset; producing an initial quantized feature direction by mapping entries of the feature direction to a restricted set of integer values; setting the initial quantized feature direction as a current quantized feature direction; iteratively improving the current quantized feature direction by: generating a candidate quantized feature direction by perturbing one or more entries of the current quantized feature direction with different values from the restricted set of integer values, evaluating the candidate quantized feature direction with respect to an objective function comprising (i) a fidelity measure between activation values produced by the candidate quantized feature direction and activation values produced by the feature direction prior to quantization and (ii) a hardware implementation cost, or a proxy thereof, of a circuit realizing the candidate quantized feature direction, and replacing the current quantized feature direction with the candidate quantized feature direction when the candidate quantized feature direction improves the objective function; and outputting data representing the current quantized feature direction for synthesis into hardware as a feature extractor.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, mathematical representations, combinations, and permutations of features, optional components, optional steps, and optional methods may be adapted for a specific environment and/or operating requirements without departing from the principles and scope of this disclosure. These and other changes or modifications, and all possible permutations and combinations of examples and embodiments disclosed, are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described with regard to various embodiments. However, benefits, advantages, solutions to problems, and any element(s) that may cause any benefit, advantage, or solution to occur or become more pronounced are not to be construed as a critical, required, or essential feature or element. Indeed, even inferior or non-optimized versions of the described embodiments are intended to be included within the scope of this disclosure. The scope of this disclosure includes all the clauses in the applications to which this application claims priority and to the numbered claims below, including all feasible combinations thereof

What is claimed is:

1. A computer-implemented method for constructing a plurality of quantized feature extractors for synthesis into hardware, the method comprising:
determining, from a dataset, a feature direction, wherein the feature direction is a vector or a tensor and comprises at least two components;
quantizing the feature direction to produce a quantized feature direction;
modifying the dataset by removing therefrom a contribution corresponding to the quantized feature direction, rather than removing therefrom a contribution corresponding to the feature direction prior to quantization, thereby producing a modified dataset that retains residual error introduced by the quantization;
iteratively repeating the determining, quantizing, and modifying to produce at least one further quantized feature direction, each further quantized feature direction being determined from a corresponding modified dataset from which contributions of previously produced quantized feature directions have been removed; and
outputting data representing the quantized feature direction and the at least one further quantized feature direction for synthesis into hardware.

2. The method of claim 1, further comprising converting at least one quantized feature direction produced by the method into a combinational-logic netlist for implementation as static logic on a field-programmable gate array or an application-specific integrated circuit.

3. The method of claim 2, wherein input dimensions corresponding to zero-valued entries of the at least one quantized feature direction are omitted from the combinational-logic netlist, and wherein entries whose magnitude is a power of two are implemented via bit shifting.

4. The method of claim 1, wherein the dataset comprises a dataset of feature extractor inputs constructed by extracting, from a dataset of interest, a collection of input vectors, each input vector corresponding to a local region, a patch, or a subset of features of the dataset of interest,
wherein determining the feature direction comprises applying a decomposition that identifies one or more of:
a direction of greatest variance of the dataset of feature extractor inputs;
a direction associated with a greatest singular value of the dataset of feature extractor inputs; and
a direction associated with a greatest eigenvalue of the dataset of feature extractor inputs.

5. The method of claim 1, wherein modifying the dataset comprises, for each data point in the dataset, computing an activation by an inner product of the data point with the quantized feature direction and subtracting from the data point an outer product of the activation with the quantized feature direction, thereby removing from the dataset a projection onto a subspace defined by the quantized feature direction rather than a subspace defined by the feature direction prior to quantization.

6. The method of claim 1, wherein the quantized feature direction defines a subspace different from a subspace defined by the feature direction prior to quantization, and wherein the modified dataset retains components that would have been removed had the feature direction prior to quantization been used, such that a subsequent feature direction determined from the modified dataset compensates, at least in part, for quantization-induced subspace deviation of the quantized feature direction.

7. The method of claim 1, wherein the determining, quantizing, and modifying are performed for at least four iterations to produce at least four quantized feature directions.

8. The method of claim 1, wherein modifying the dataset further comprises augmenting at least one data point in the modified dataset with at least one additional element representing an output activation of a previously identified quantized feature extractor.

9. The method of claim 1, wherein the plurality of quantized feature extractors are for use in a hardware implementation of an inference system processing real-valued or integer-valued inputs.

10. The method of claim 1, wherein the dataset comprises a dataset of feature extractor inputs constructed by extracting, from a dataset of interest, a collection of input vectors, each input vector corresponding to a local region, a patch, or a subset of features of the dataset of interest, and wherein the method further comprises, for at least one quantized feature direction produced by the method:
computing an activation distribution by applying the at least one quantized feature direction to the dataset of feature extractor inputs;
determining a plurality of thresholds from the activation distribution, including a plurality of quantile or quantile-based thresholds; and
defining a feature extractor configured to produce a multi-bit output by comparing an activation produced from an input using the at least one quantized feature direction against the plurality of quantile or quantile-based thresholds.

11. The method of claim 1, further comprising constructing a second level of feature extractors by:
applying a first level of quantized feature extractors to data derived from the dataset to produce intermediate feature representations;
constructing a second dataset from the intermediate feature representations; and
performing the determining, quantizing, and modifying on the second dataset to obtain a second plurality of quantized feature directions,
wherein precision of the intermediate feature representations is reduced before constructing the second dataset by omitting least significant bits or by linear or non-linear quantization of the intermediate feature representations.

12. The method of claim 1, wherein the quantized feature direction has entries selected from a set {−2, −1, 0, 1, 2}.

13. The method of claim 1, wherein quantizing the feature direction comprises applying a rounding function biased toward values associated with lower hardware implementation cost, including a bias toward zero.

14. The method of claim 1, wherein determining the feature direction comprises extracting a trained weight vector from a layer of a neural network that has been trained on the dataset or on a related dataset.

15. The method of claim 1, further comprising:
identifying, across the plurality of quantized feature extractors, a multi-element tuple of input signal dimensions for which two or more of the quantized feature extractors assign identical or proportional nonzero coefficient values;
creating a merged channel representing a sum or weighted sum of the input signal dimensions of the multi-element tuple;
replacing, in the two or more quantized feature extractors, references to the multi-element tuple with a reference to the merged channel and adjusting one or more coefficients to account for the replacement; and
outputting data representing the quantized feature extractors and the merged channel for synthesis into shared hardware in which the merged channel corresponds to a shared arithmetic unit routed to the two or more quantized feature extractors that reference the merged channel, thereby reducing a total number of arithmetic operations relative to independent implementation of the plurality of feature extractors.

16. An application-specific integrated circuit (ASIC), comprising:
input circuitry configured to receive an inference input and to form a feature extractor input vector therefrom;
feature extraction circuitry configured to compute one or more activation values according to a quantized feature direction and at least one further quantized feature direction embodied in the ASIC; and
feature output circuitry configured to generate one or more feature outputs from the one or more activation values, wherein the ASIC is manufactured based on data representing the quantized feature direction and the at least one further quantized feature direction, the data being produced by a process comprising:
determining, from a dataset, a feature direction, wherein the feature direction is a vector or a tensor and comprises at least two components;
quantizing the feature direction to produce a quantized feature direction;
modifying the dataset by removing therefrom a contribution corresponding to the quantized feature direction, rather than removing therefrom a contribution corresponding to the feature direction prior to quantization, thereby producing a modified dataset that retains residual error introduced by the quantization;
iteratively repeating the determining, quantizing, and modifying to produce at least one further quantized feature direction, each further quantized feature direction being determined from a corresponding modified dataset from which contributions of previously produced quantized feature directions have been removed; and
outputting data representing the quantized feature direction and the at least one further quantized feature direction for synthesis into hardware.

17. A computer-implemented method for constructing a shared hardware implementation of a plurality of feature extractors, each feature extractor defined by coefficients over a common set of input signal dimensions or over respective overlapping sets of input signal dimensions, the method comprising:
identifying, across the plurality of feature extractors, a selected multi-element tuple of input signal dimensions that satisfies a sharing criterion for a plurality of the feature extractors, the sharing criterion comprising at least one criterion selected from a set of criteria that includes: (i) respective feature extractors assigning identical nonzero coefficient values to the input signal dimensions of the multi-element tuple, and (ii) respective feature extractors assigning proportional nonzero coefficient values to the input signal dimensions of the selected multi-element tuple;
creating a merged channel representing a sum or weighted sum of the input signal dimensions of the selected multi-element tuple;
modifying, for at least some of the feature extractors that satisfy the sharing criterion for the selected multi-element tuple, the at least some feature extractors by replacing references to the selected multi-element tuple with a reference to the merged channel and adjusting one or more coefficients to account for the replacement;
iteratively repeating the identifying, creating, and modifying using a modified set of feature extractors, including previously created merged channels as candidates for further merging; and
outputting data representing the modified set of feature extractors and the merged channels for synthesis into shared hardware,
wherein each merged channel corresponds to a shared arithmetic unit whose output is routed to two or more feature extractors that reference the merged channel, thereby reducing a total number of arithmetic operations relative to independent implementation of the plurality of feature extractors.

18. The method of claim 17, wherein outputting data representing the modified set of feature extractors and the merged channels comprises outputting a combinational-logic netlist or configuration data for implementation on a field-programmable gate array or in an application-specific integrated circuit.

19. The method of claim 17, wherein the input signal dimensions comprise any combination of one or more of: input channels; channels of a multi-channel input signal; spatial positions within a kernel, patch, receptive field, or window; entries of a feature extractor input vector; feature indices; and temporal positions.

20. The method of claim 17, wherein the selected multi-element tuple comprises a selected pair of input signal dimensions, wherein identifying the selected pair comprises evaluating coefficient values assigned by the plurality of feature extractors to pairs of input signal dimensions and selecting the selected pair together with a matching nonzero coefficient value for which a count of feature extractors assigning the matching nonzero coefficient value to both input signal dimensions of the selected pair is maximized under constraints including hardware efficiency constraints, and
wherein modifying the at least some feature extractors that assign the matching nonzero coefficient value to both input signal dimensions of the selected pair comprises setting coefficient entries for the selected pair to zero and introducing a nonzero coefficient entry for the merged channel, thereby reducing a number of nonzero coefficient entries in the feature extractor.
